(19) United States
(12) Patent Application Publication
(10) Pub. No.: US 2010/0312645 A1
(43) Pub. Date: Dec. 9, 2010

(54) Systems and Methods to Facilitate Purchases on Mobile Devices

(75) Inventors: Martine NIEJADLIK, Los Altos, CA (US); Michael WILLIAMS, Chesterfield (GB); Jonathan Michael KINGSTON, Chesterfield (GB)

Correspondence Address: GREENBERG TRAURIG, LLP (SV);IP DOCKETING, 2450 COLORADO AVENUE, SUITE 400E, SANTA MONICA, CA, 90404, US

(73) Assignee: BOKU, INC., San Francisco, CA (US)

(21) Appl. No.: 12/795,586

(22) Filed: Jun. 7, 2010

Related U.S. Application Data
(60) Provisional application No. 61/185,569, filed on Jun. 9, 2009.

(51) Int. Cl. G06Q 30/00; H04M 3/42

(52) U.S. Cl. 705/14.55; 455/414.1

(57) ABSTRACT

Systems and methods to provide information to facilitate online transactions via mobile communications. In one aspect, a system includes an interchange and a data storage facility storing information identifying an item and a seller of the item. The interchange includes a common format processor and a plurality of converters to interface with a plurality of different controllers of mobile communications. The converters are configured to communicate with the common format processor in a common format and with the controllers in different formats. When an advertisement of the item is selected on a mobile phone, the interchange uses the converters to communicate with the mobile phone to confirm the request to purchase the item via premium messages. The interchange automatically identifies the seller using the information stored on the data storage facility and electronically purchases the item on behalf of the user of the mobile phone.

### CROSS-REFERENCE TO RELATED APPLICATIONS

The present application claims priority to provisional U.S. Patent Application Ser. No. 61/185,569, filed Jun. 9, 2009 and entitled “Systems and Methods to Facilitate Purchases on Mobile Devices,” the disclosure of which is incorporated herein by reference.

### FIELD OF THE TECHNOLOGY

At least some embodiments of the disclosure relate to mobile communications in general and, more particularly but not limited to, mobile communications to facilitate online transactions.

### BACKGROUND

Short Message Service (SMS) is a communications protocol that allows the interchange of short text messages between mobile telephone devices. SMS messages are typically sent via a Short Message Service Center (SMSC) of a mobile carrier, which uses a store-and-forward mechanism to deliver the messages. When a mobile telephone is not reachable immediately for the delivery of the message, the SMSC stores the message for later retry.

SMS messages can be sent via gateways. Some gateways function as aggregators. An aggregator typically does not have the capacity to deliver the messages directly to the mobile phones. An aggregator typically interfaces with and relies upon the SMSC of a mobile carrier to deliver SMS messages.

Some gateways function as providers that are capable of sending text messages to mobile devices directly, without going through the SMSC of other mobile operators.

Text messaging between mobile telephones can also be performed using other protocols, such as SkyMail and Short Mail in Japan.

Some mobile carriers provide email gateway services to allow text messages to be sent to mobile phones via email. For example, a non-subscriber of the mobile carrier may send a message to an email address associated with a mobile phone of a subscriber of the mobile carrier to have the message delivered to the mobile phone via text messaging.

Emails can also be sent to mobile telephone devices via standard mail protocols, such as Simple Mail Transfer Protocol (SMTP) over Internet Protocol Suite (commonly TCP/IP, named from two of the protocols: the Transmission Control Protocol (TCP) and the Internet Protocol (IP)).

Short messages may be used to provide premium services to mobile phones, such as news alerts, ring tones, etc. The premium content providers may send the messages to the SMSC of the mobile operator using a TCP/IP protocol, such as Short Message Peer-to-peer Protocol (SMPP) or Hypertext Transfer Protocol, for delivery to a mobile phone; and the mobile phone is billed by the mobile operator for the cost of receiving the premium content.

Premium services may also be delivered via text messages initiated from the mobile phone. For example, a televoting service provider may obtain a short code to receive text messages from mobile phones; and when the user sends a text message to the short code, the mobile carrier routes the message to the televoting service provider and charges the user a fee, a portion of which is collected for the televoting service provider.

### SUMMARY OF THE DESCRIPTION

Systems and methods to provide information to facilitate online transactions via mobile communications are described here. Some embodiments are summarized in this section.

In one aspect, a system includes: a data storage facility to store information identifying an item and a seller of the item, the item to be presented in an advertisement to a mobile phone at a phone number; and an interchange coupled with the data storage facility. The advertisement has an indication of the item offered in the advertisement and a reference to the interchange to generate a request to the interchange when the advertisement is selected, the request including the indication of the item and the phone number of the mobile phone. The interchange includes a common format processor and a plurality of converters to interface with a plurality of different controllers of mobile communications. The converters are configured to communicate with the controllers in different formats; and the converters are configured to communicate with the common format processor in a common format.

In one embodiment, the common format processor is configured to instruct a first controller of the controllers, via a first converter of the converters, to communicate with a mobile phone at the mobile phone number of the user to confirm the request to purchase the item with funds associated with the phone number, and to send one or more premium messages to the mobile phone to collect the funds. The interchange is configured to identify the seller based on the indication of the item and the information stored in the data storage facility, and to communicate with a server of the seller to electronically purchase the item on behalf of a user of the mobile phone, using the funds associated with the phone number.

In another aspect, a method includes: storing, by a server computer, information identifying an item and a seller of the item, the item to be presented in an advertisement to a mobile phone at a phone number, the advertisement having a reference to the server computer to generate a request to the server computer when the advertisement is selected, the advertisement further having an indication of the item offered in the advertisement; receiving, at the server computer, the request generated in response to the advertisement being selected in the mobile phone, the request including the indication of the item and the phone number of the mobile phone; identifying, by the server computer, the seller based on the indication of the item and the information stored by the server computer; and communicating, by the server computer, with a server of the seller to electronically purchase the item on behalf of a user of the mobile phone, using the funds associated with the phone number.

The disclosure includes methods and apparatuses which perform these methods, including data processing systems which perform these methods, and computer readable media containing instructions which when executed on data processing systems cause the systems to perform these methods.

Other features will be apparent from the accompanying drawings and from the detailed description which follows.

### BRIEF DESCRIPTION OF THE DRAWINGS

The embodiments are illustrated by way of example and not limitation in the figures of the accompanying drawings in which like references indicate similar elements.

FIG. 1 shows a system to facilitate online transactions according to one embodiment.

FIG. 2 shows an interchange to route messages according to one embodiment.

FIG. 3 shows a message processor according to one embodiment.

FIG. 4 shows a method to facilitate an online transaction using an interchange according to one embodiment.

FIG. 5 illustrates a user interface to associate an account with a telephone number according to one embodiment.

FIG. 6 illustrates another user interface to associate an account with a telephone number according to one embodiment.

FIG. 7 illustrates a user interface to initiate a payment transaction according to one embodiment.

FIG. 8 illustrates a user interface to initiate a payment request according to one embodiment.

FIG. 9 illustrates a user interface to confirm a payment request according to one embodiment.

FIG. 10 illustrates a user interface to confirm the completion of a payment transaction according to one embodiment.

FIG. 11 illustrates a way to redirect a payment confirmation according to one embodiment.

FIG. 12 illustrates a user interface to receive payment options according to one embodiment.

FIG. 13 shows a method to process an online payment according to one embodiment.

FIG. 14 shows another method to facilitate a payment transaction according to one embodiment.

FIGS. 15-18 show methods to approve a payment transaction according to some embodiments.

FIG. 19 shows a user interface to provide user information in connection with payment processing according to one embodiment.

FIG. 20 shows a user interface to provide user information to facilitate payment processing according to one embodiment.

FIGS. 21 and 22 illustrate user interfaces for authentication according to some embodiments.

FIG. 23 shows a method to provide information according to one embodiment.

FIG. 24 shows an advertisement on a mobile phone according to one embodiment.

FIG. 25 shows a message to confirm a purchase made via an advertisement on a mobile phone according to one embodiment.

FIGS. 26-28 illustrate systems to facilitate purchases on a mobile phone according to some embodiments.

FIGS. 29-30 show methods to facilitate purchases on a mobile phone according to some embodiments.

FIG. 31 shows a data processing system, which can be used in various embodiments.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In one embodiment, an interchange is used to interface with a plurality of different controllers of mobile communications, such as SMS messages. The interchange can be used to associate account information with phone numbers to facilitate electronic payments via mobile devices, such as cellular phones. The interchange is configured to communicate with the mobile phones through the different controllers to provide security and convenience for online transactions.

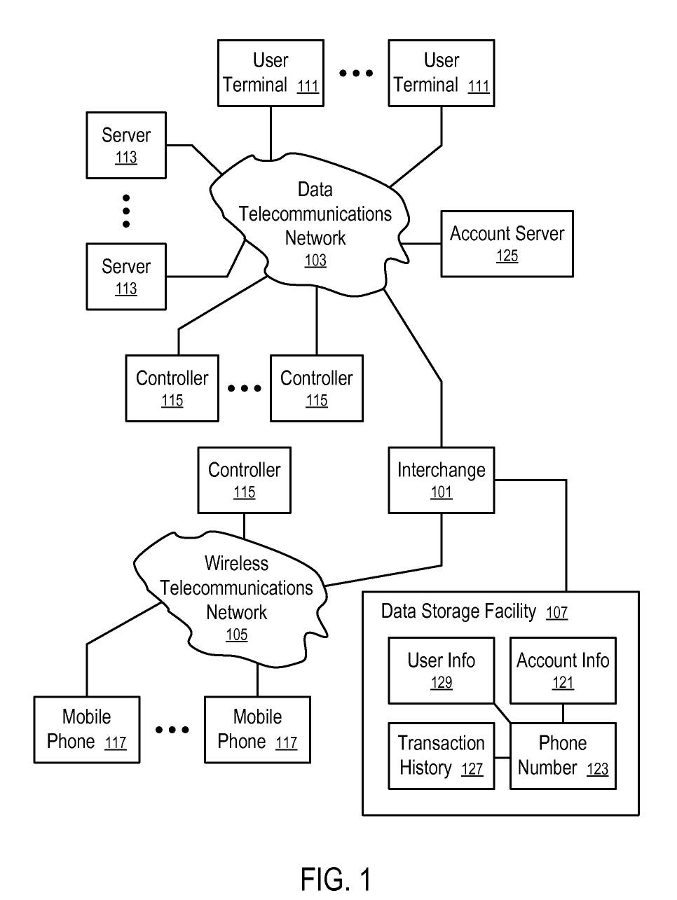

FIG. 1 shows a system to facilitate online transactions according to one embodiment. In FIG. 1, an interchange (101) is provided to interface with a plurality of different controllers (115) for communications with the mobile phones (117) over the wireless telecommunications network (105).

In FIG. 1, a data storage facility (107) stores user account information (121) and the corresponding phone numbers (123) of the mobile phones (117). The interchange (101) is coupled with the data storage facility (107) to communicate with the mobile phones (117) at the corresponding phone numbers (123) to confirm operations that are performed using the account information (121). Since the account information (121) is secured by the interchange (101), the account information (121) can be used to pay for products and services offered by the servers (113) of various merchants, without being revealed to the merchants.

In one embodiment, the server (113) offers products and/or services adapted for a virtual world environment, such as an online game environment, a virtual reality environment, etc. The products may be virtual goods, which can be delivered via the transmission of data or information (without having to physically deliver an object to the user). For example, the virtual goods may be a song, a piece of music, a video clip, an article, a computer program, a decorative item for an avatar, a piece of virtual land in a virtual world, a virtual object in a virtual reality world, etc. For example, an online game environment hosted on a server (113) may sell services and products via points or virtual currency, which may be consumed by the user while engaging in a game session. For example, a virtual reality world hosted on a server (113) may have a virtual currency, which may be used by the residents of the virtual reality world to conduct virtual commerce within the virtual reality world (e.g., buy virtual lands, virtual stocks, virtual objects, services provided in the virtual reality world, etc). In other embodiments, the server (113) may also offer physical goods, such as books, compact discs, photo prints, postcards, etc.

In FIG. 1, the interchange (101) may communicate with different controllers (115) of mobile communications via different networks (e.g., 105 and 103) and/or protocols. The interchange (101) processes the requests in a common format and uses a set of converters for communications with the different controllers (115) respectively.

For example, the controllers (115) may be different aggregators, providers and/or SMSCs of different mobile carriers. Based on the phone numbers (123), the interchange (101) interfaces with the corresponding controllers (115) to communicate with the mobile phones (117) via text messaging to confirm the operations related to the corresponding account information (121), such as bank accounts, credit card numbers, charge card numbers, etc.

In FIG. 1, the user terminals (111) may use a unified interface to send requests to the interchange (101). For example, a website of the interchange (101) may be used to receive the account information (121) from the web browsers running in the user terminals (111). The user terminals (111) are typically different from the mobile phones (117). However, in some embodiments, users may use the mobile phone (117) to access the web and submit the account information (121). Alternatively, the users may use the mobile phone (117) to submit the account information (121) to the interchange (101) via text messaging, email, instant messaging, etc.

The use of the mobile phones (117) in the confirmation of activities that involve the account information (121) increases the security of the transaction, since the mobile phones (117) are typically secured in the possession of the users.

Further, in one embodiment, the interchange (101) may use the phone bills of the mobile phones (117) to pay for purchases, in order to use the account information (121) to pay for the phone bills, and/or to deposit funds into the accounts identified by the account information (121) by charging on the phone bills of the corresponding mobile phones (117). In some embodiments, the accounts identified by the account information (121) are hosted on the data storage facility (107). In other embodiments, the accounts are hosted on the account servers (125) of financial institutions, such as banks, credit unions, credit card companies, etc.

In one embodiment, once the account information (121) is associated with the mobile phones (117) via their phone numbers (123) stored in the data storage facility (107), the users may use the user terminals (111) to access online servers (113) of various merchants or service providers to make purchases. From the user terminals (111), the users can use the accounts identified by the account information (121) to make the payment for the purchases, without revealing their account information (121) to the operators of the servers (113).

In one embodiment, the mobile phones (117) are used by the corresponding users to make payments and/or manage funds, such as for making purchases in various websites hosted on the servers (113) of merchants and service providers and/or for transferring funds to or from an account identified by the account information (121), such as phone bills of land-line telephone services, credit card accounts, debit card accounts, bank accounts, etc., or an account hosted on the data storage facility (107) or telecommunication accounts of the mobile phones (117) with telecommunication carriers. The mobile phones (117) are used to confirm and/or approve the transactions associated with the account identified by the account information (121) (or other accounts). The interchange (101) interfaces the mobile phones (117) and the servers (113) to confirm and/or approve transactions and to operate on the account identified by the account information (121) (and/or other accounts associated with the phone number (123)).

For example, the user terminal (111) may provide the phone numbers (123) to the servers (113) to allow the servers (113) to charge the account identified by the account information (121) associated with the phone number (123). The interchange (101) sends a message to the mobile phone (117) via the phone number (123) to confirm the payment request. Once the payment is confirmed or approved via the corresponding mobile phone (117), the interchange (101) charges the account identified by the account information (121) (e.g., by communicating with the account server (125) on which the corresponding accounts are hosted) and pays the server (113) on behalf of the user, using the funds obtained from the corresponding account identified by the account information (121).

In one embodiment, the user terminal (111) may not even provide the phone number (123) to the server (113) to process the payment. The server (113) may redirect a payment request to the interchange (101), which then prompts the user terminal (111) to provide the phone number (123) to the website of the interchange (101) to continue the payment process.

For example, the server (113) may redirect the payment request to the website of the interchange (101) with a reference indicating the purchase made via the user terminal (111). The interchange (101) can use the reference to subsequently complete the payment with the server (113) for the purchase, after receiving the phone number (123) directly from the user terminal (111) to confirm the payment via the mobile phone (117).

In some embodiments, instead of directly providing the phone number (123) to identify the account information (121), the user may provide other information to identify the phone number (123), such as an account identifier of the user assigned to the user for obtaining the services of the interchange (101).

In one embodiment, the account information (121) is pre-associated with the phone number (123) prior to the payment request. The account information (121) may be submitted to the interchange (101) via the user terminal (111) or the mobile phone (117) via a secure connection.

Alternatively, the user may supply the account information (121) to the interchange (101) at the time the payment request is submitted from the user terminal (111) to the interchange (101). Alternatively, the user may supply the account information (121) to the interchange (101) at the time the user responds to the confirmation message for the payment request.

In some embodiments, the user may supply the account information (121) after a transaction using funds collected via the telecommunication carrier of the mobile phone (117) at the phone number (123). For example, after the transaction, the interchange (101) may send an invitation message, such as a text message to the mobile phone (117) at the phone number (123), to the user to invite the user to register with the interchange (101) and provide the account information (121). The user may register with the interchange (101) via the mobile phone (117) (e.g., by a replying text message), or via a web page of the interchange (101) (e.g., using a link and/or a unique code provided in the invitation message).

After the user registers with the interchange (101) (e.g., via the mobile phone (117) and by providing the account information (121)), the user may create a customized personal identification number (PIN) or receive a PIN for enhanced security. Using the PIN, the user may use the account information (121) to complete an online transaction without having to confirm and/or approve a transaction using the mobile phone (117). In some embodiments, the PIN may be used to reduce unwanted messages to the mobile phone (117). For example, once the phone number (123) and the account information (121) are associated with a PIN, the interchange (101) may require the user of the user terminal (111) to provide the correct PIN to initiate the payment process. Thus, a spammer having only the phone number (123) (or a different user mistakenly using the phone number (123)) may not successfully use the user terminal (111) to request the interchange (101) to send confirmation messages to the mobile phone (117) protected by the PIN. In some embodiments, the interchange (101) may offer further incentives to the user for registering with the interchange (101), such as reduced fees, discounts, coupons, free products and services, etc.

In one embodiment, once the account information (121) is associated with the phone number (123) in the data storage facility (107), the user does not have to resubmit the account information (121) in subsequent payment requests.

By delegating the payment task to the interchange (101) and securing the account information (121) in the data storage facility (107), the system as shown in FIG. 1 can increase the security of using the account information (121) in an online environment.

In some embodiments, the interchange (101) can also fulfill the payment requests using the funds collected via the phone bill of the phone numbers (123). The interchange (101) can collect the funds via sending premium messages to the mobile phones (117) at the phone numbers (123), after receiving confirmation from the mobile phone (117).

For example, after the confirmation or approval message is received from the mobile phone (117), the interchange (101) performs operations to collect funds via the phone bill of the phone number (123). The interchange (101) may calculate the required premium messages to bill to the mobile phone (117). For example, mobile terminated premium SMS messages may have a predetermined set of prices for premium messages. The interchange (101) determines a combination of the premium messages that has a price closest to the amount required by the transaction, and sends this combination of premium messages to the mobile phone (117). For example, mobile originated premium SMS messages may also have a predetermined set of prices for premium messages. The interchange (101) can calculate the set of messages required for the transaction and transmit a text message to the mobile phone (117) of the user to instruct the user to send the required number of premium messages to provide the funds.

In one embodiment, the data storage facility (107) stores the transaction history (127) associated with the phone number (123) and uses the transaction history (127) to approve payment requests and to reduce the time period for processing a subsequent payment request.

For example, from the transaction history (127) the interchange (101) may identify a pattern of prior payment requests made via the phone number (123) and match subsequent requests with the identified pattern. When a subsequent request matches the pattern, the interchange (101) may skip the communication with the mobile phone (117) at the phone number (123), which communication is otherwise performed after the payment request and before the payment operation for payment confirmation and/or approval. Skipping such a communication between the payment request and the payment operation can reduce the time period for payment processing and improve user experience.

Examples of transaction patterns may include the use of the individual user terminals (111), the typical time period of payment requests, range of payment amounts, and/or certain characteristics of payees, such as a collection of frequently used payees, payees who provide certain types of products or services, the geographical region of payees, etc.

In one embodiment, when the subsequent payment request is received within a predetermined time limit of a previous confirmed payment request from the same user terminal (111), the interchange (101) may approve the payment request without communicating with the mobile phone (117) at the phone number (123) for approval or confirmation.

In one embodiment, when the interchange (101) skips the communication with the mobile phone (117) at the phone number (123) for approval or confirmation and approves a transaction request based on the transaction history (127), the interchange (101) may send a notification message to the mobile phone (117) at the phone number (123) for enhanced security but not requiring a response from the user. If the user determines that the notification message corresponds to an unauthorized use of the phone number (123), the user may reply to the notification message from the mobile phone (117) to report the unauthorized use and/or stop or reverse the payment operation.

In some embodiments, the user may start a session (e.g., a web session) authenticated using a password associated with the phone number (123), prior to the payment request. When the payment request is made within the authenticated session (e.g., before the user logs off the session, or before the session times out), the interchange (101) may skip the confirmation/approval communication with the mobile phone (117) at the phone number (123) to reduce the time period for payment processing.

In one embodiment, the session is authenticated via communications with the mobile phone (117) at the phone number (123). For example, after the user provides the phone number (123) to log into a session on a user terminal (111), the interchange (101) may generate a code (e.g., a code for one time use) and send the code to the user via the user terminal (111) (or the mobile phone (117) at the phone number (123)). The interchange (101) then requests the code back from the user via the mobile phone (117) at the phone number (123) (or the user terminal (111)), which is not used to send the code. When the code sent by the interchange (101) matches the code received back from the user, the association between the user terminal (111) and the mobile phone (117) at the phone number (123) can be established; and the identity of the user of the user terminal (111) can be confirmed. Such confirmation can be logged in the transaction history (127) for subsequent approval of payment requests.

In one embodiment, the user may specify a time period for the session, or the time period for the association between the user terminal (111) and the phone number (123). The user may specify the time period using the user terminal (111) when providing the phone number (123) to initiate the session, or specify the time period using the mobile phone (117) when providing the one-time code back to the interchange (101). During the time period of the confirmed association between the user terminal (111) and the phone number (123), a payment request from the user terminal (111) can be automatically identified with the phone number (123) without the user having to explicitly specify the phone number (123) for the payment request. Alternatively, for enhanced security and/or flexibility, the interchange (101) may require the user to identify the phone number (123) in the payment request, even though the payment request is from the user terminal (111) that is associated with the phone number (123).

In one embodiment, the code for the authentication of the session can be communicated to and/or from the mobile phone (117) via short message service (SMS), voice message, voice mail, or other services, such as email, instant messaging, multimedia messaging service (MMS), etc.

In one embodiment, after the user provides the phone number (123) to log into a session on a user terminal (111), the interchange (101) provides a message to the mobile phone (117) at the phone number (123) and receives a reply to the message from the mobile phone (117) within a predetermined period of time to authenticate the session and associate the user terminal (111) with the phone number (123). If the reply is not received from the mobile phone (117) with the predetermined period of time, the session is not authenticated.

In one embodiment, the user may provide an advance approval for subsequent payment requests to pay via the phone number (123). The advance approval may include a number of limitations, such as the time limit for the expiration of the advance approval, the budget limit for the advance approval, a limit on payees for the advance approval, etc. For example, the advance approval may limit the payees based on their business category, web address, product type, service type, geographic location, etc. For example, the budget limit may include the frequency of subsequent payment requests, limit for individual payment requests, and total limit for subsequent payment requests, etc.

In one embodiment, the advance approval is specific for a user terminal. For example, the advance approval may be obtained via communications with the user via both a specific user terminal (111) and the mobile phone (117) at the phone number (123). Thus, the advance approval applies only to subsequent payment requests from the specific user terminal (111) identified by the advance approval.

Alternatively, the advance approval may not be limited to a specific user terminal (111). The advance approval may be used for any user terminals (111) used by the user of the phone number (123) to request payments via the phone number (123). In some embodiments, the advance approval is limited to user terminals (111) of certain characteristics identified by the advance approval, such as a geographic region of the user terminal (111) (e.g., determined based on the communication addresses, routing paths, access points for wireless connections, base stations for cellular communications, etc.). In some embodiments, the interchange (101) automatically identifies these characteristics based on the communications to obtain the advance approval (e.g., based on transaction history (127)), without the user explicitly specifying the characteristics.

In one embodiment, the data storage facility (107) also stores user information (129) associated with the phone number (123). When authorized, the interchange (101) provides the user information (129) to the servers (113) to facilitate transactions between the user terminals (111) and the servers (113).

For example, the user information (129) may include shipping address, billing address, user preferences, login credentials, etc. In some embodiments, the interchange (101) may also provide the account information (121) to the server (113) to allow the server (113) to charge the user using the account information (121). Thus, the account information (121) may also be considered as part of the user information (129) in some embodiments.

In one embodiment, after a request for payment to a merchant is confirmed/approved via the mobile phone (117) at the phone number (123), the interchange (101) provides the server (113) with the user information (129) that is associated with the phone number (123) in the data storage facility (107), to provide assistance in the transaction. For example, the user may store the shipping address as part of the user information (129) associated with the phone number (123) on the data storage facility (107). After the interchange (101) finishes processing the payment request, the interchange (101) may provide the shipping address to the server (113) to allow the merchant to ship a product to the user; thus, the user does not have to manually submit the shipping address to various servers (113).

In one embodiment, after a request is confirmed/approved via the mobile phone (117) at the phone number (123), the interchange (101) may provide at least a portion of the account information (121) to the server (113) to allow the server (113) to process the payment using the account information (121). For example, the interchange (101) may provide the account identifier (e.g., a credit card number, a bank account number, a debit card number), or a portion of the account identifier, to the server (113) to allow the server (113) to charge the user using the account identifier. Thus, the user does not have to manually supply the corresponding information to the server (113). In one embodiment, the entire account identifier is provided to the server (113) for the convenience of the user. In one embodiment, a partial account identifier is provided to the server (113) to balance convenience and security; and the user provides the remaining portion of the account identifier directly to the server (113) to complete the transaction. In some embodiments, the interchange (101) provides the server (113) with information related to account type, expiration date, billing address, etc. to assist the user in the check out process on the server (113). In some embodiments, the interchange (101) does not provide the account identifier to the server (113) for improved security; and the server (113) obtains the account identifier from the user directly and obtains other information, such as account type, expiration date, billing address, etc. from the interchange (101).

In one embodiment, the interchange (101) dynamically determines the amount of information that is provided to the server (113). For example, the decision may be based on matching the current transaction with a pattern of past transactions (e.g., determined based on the transaction history (127)) and/or the security levels at the server (113). When there is a match, some of the information that is not otherwise provided may be provided from the interchange (101) to the server (113), such as a portion of the account information (121).

In some embodiments, the interchange (101) provides the information to the server (113) based on an advance approval obtained from the mobile phone (117), or based on an approval decision made based on the transaction history (127).

In one embodiment, the interchange (101) provides the user information (129) to sign into an authenticated session with the server (113). In some embodiments, the authenticated session is associated with the interchange (101) and/or used as an advance approval for payment requests occurring in the session.

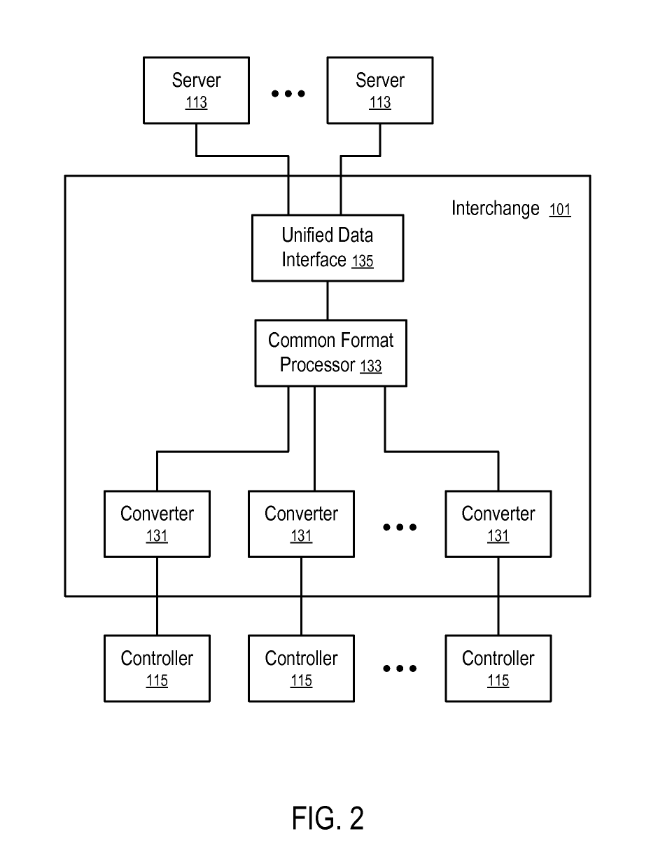

FIG. 2 shows an interchange to route messages according to one embodiment. In FIG. 2, the interchange (101) includes a unified data interface (135) for interaction with the servers (113). The servers (113) may redirect the payment requests to the interchange (101) to allow the interchange (101) to subsequently communicate with the user to process the payment request, including obtaining payment options and identifying user accounts (123), before returning to communicating with the server (113). Alternatively, the servers (113) may collect account related information (e.g., the phone number of the user) to request payment from the interchange (101).

In FIG. 2, the interchange (101) includes a common format processor (133), which processes various payment options in a common format. In one embodiment, the common format processor (133) can handle the payments via mobile terminated text message, mobile originated text message, operator bill, credit card, stored value account, and other online payment options. The common format processor (133) determines the actual amount that is to be billed to the user, based on the payment options (e.g., mobile terminated premium SMS, mobile originated premium SMS, operator billing, credit cards, etc.), and selects a converter (131) to communicate with a corresponding controller (115).

Different converters (131) are configured to communicate with corresponding controllers (115) in different languages and protocols. The converters (131) perform the translation between the common format used by the common format processor (133) and the corresponding formats used by the controllers (115).

The use of the common format processor (133) simplifies the structure of the interchange (101) and reduces the development effort required for the interchange (101) to interface with the increasing number of different controllers, such as SMSC, mobile providers, aggregators, gateways, etc.

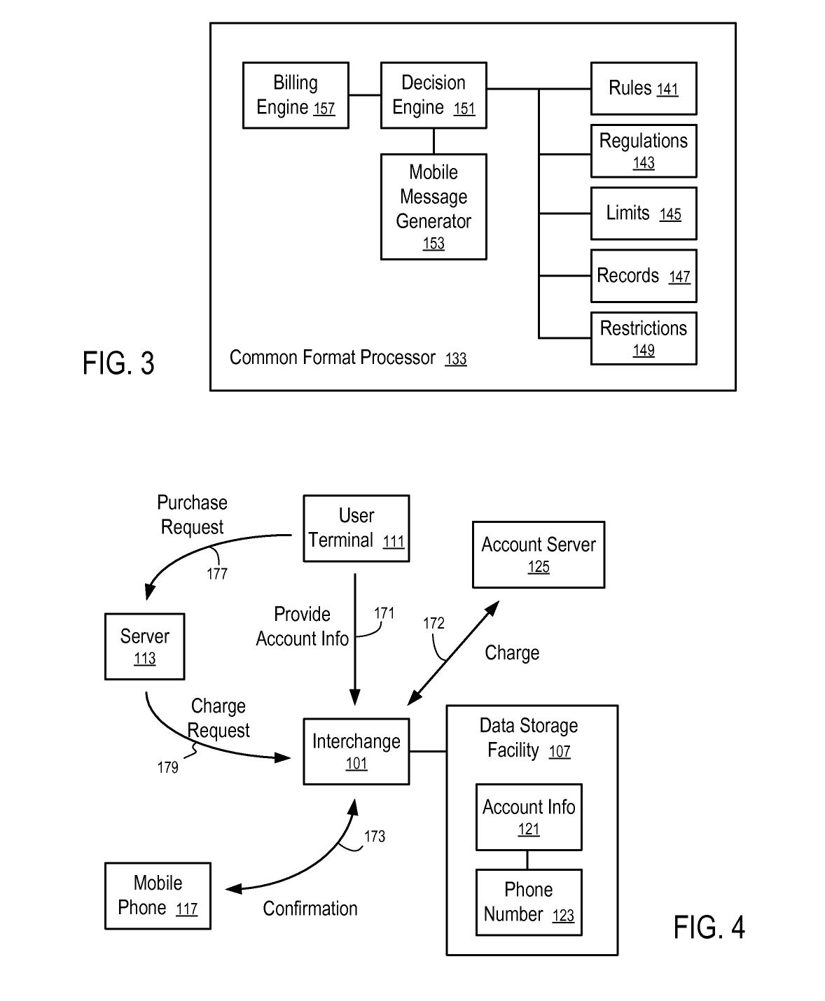

FIG. 3 shows a message processor according to one embodiment. In FIG. 3, the common format processor (133) includes a billing engine (157) that calculates the amount to be billed to the user, by adding or subtracting transaction costs for different billing methods, such as mobile terminated text message, mobile originated text message, operator billing, credit card, stored value account, and other online payment options.

In one premium message billing method, the interchange (101) sends mobile terminated premium SMS messages to the mobile phone (117) to bill the user, or requests the mobile phone (117) to send mobile originated premium SMS messages to a short code representing the interchange (101).

In one operator billing method, the interchange (101) directly sends a message to the mobile carrier of the mobile phone (117) to bill the amount on the phone bill of the mobile phone (117), without having to send a premium message to the mobile phone (117).

The common format processor (133) includes a decision engine (151) which decides how to generate a set of one or more messages to the mobile phone (117) based on a set of rules (141), regulations (143), limits (145), records (147) and restrictions (149).

For example, different countries have different regulations (143) governing the mobile communications with the mobile phones (117). For example, different mobile carriers have different rules (141) regarding premium messages. For example, past transaction records (147) can be used to monitor the transactions to discover suspected fraudulent activities. For example, parental limits (145) and merchant restrictions (149) can be imposed.

Based on results of the decision engine (151), the mobile message generator (153) generates one or more messages to communicate with the mobile phone (117) about the transaction (e.g., a request to collect funds via the phone bill of the user for a payment request, or for deposit into an account identified by the account information (121)). The converter (131) then interfaces with the corresponding controller (115) to transmit the messages to the mobile phones (117).

FIG. 4 shows a method to facilitate an online transaction using an interchange according to one embodiment. In FIG. 4, the user terminal (111) provides (171) account information (121) to the interchange (101) for association with the phone number (123). For example, the user may use a device running a web browser as the user terminal (111) to submit the account information (121) via a secure web connection. The user terminal (111) is typically different from the mobile phone (117). However, in some embodiments, the mobile phone (117) may also be used as the user terminal (111) to submit the account information (121) (e.g., via a wireless application protocol (WAP) application, or via a message sent via short message service (SMS) or multimedia message service (MMS), or via an email message or an instant message).

After the user provides the account information (121) to the interchange (101) for storage in the data storage facility (107), the user can send (177) a charge request to the server (113) of a merchant from the user terminal (111). The server (113) of the merchant can send or redirect (179) the charge request to the interchange (101). In response to the charge request, the interchange (101) sends (173) a confirmation message to the mobile phone (117). If the user sends (173) an approval, or an appropriate reply, to the confirmation message from the mobile phone (117), the interchange (101) communicates with the account server (125) to charge an account of the user identified by the account information (121), without revealing the account information (121) to the server (113). The interchange (101) pays the merchant on behalf of the user using the funds collected via charging the account of the user. For example, the interchange (101) may use its own bank account to pay the merchant operating the server (113). Thus, the financial information of the user is not revealed to the merchant.

Upon the completion of the payment process, the interchange (101) can notify the user via the mobile phone (117) and/or the user terminal (111).

In some embodiments, the server (113) of the merchant redirects the charge request to allow the user terminal (111) to communicate with the interchange (101) to continue the payment process; and the user terminal (111) may provide (171) the account information (121) directly to the interchange (101) after the charge request is redirected.

In alternative embodiments, the user may provide the account information (121) from the mobile phone (117) together with the approval of the charge request.

In one embodiment, the interchange (101) communicates with the mobile phone (117) for the confirmation of the charge request via SMS messages. Alternatively, the confirmation and approval messages can be sent (173) via emails, instant messages, voice message, live calls from operators, etc.

In some embodiments, the user of the mobile phone (117) may choose to fulfill the charge request via the phone bill, instead of charging the account identified by the account information (121). Thus, after the confirmation, the interchange (101) sends the premium messages to the mobile phone (117) to collect funds via the phone bill of the mobile phone (117). In other embodiments, the interchange (101) may send an instruction with the confirmation message to the mobile phone (117) to instruct the user to send mobile originated premium messages to the interchange (101) to collect the funds via the phone bill of the mobile phone (117).

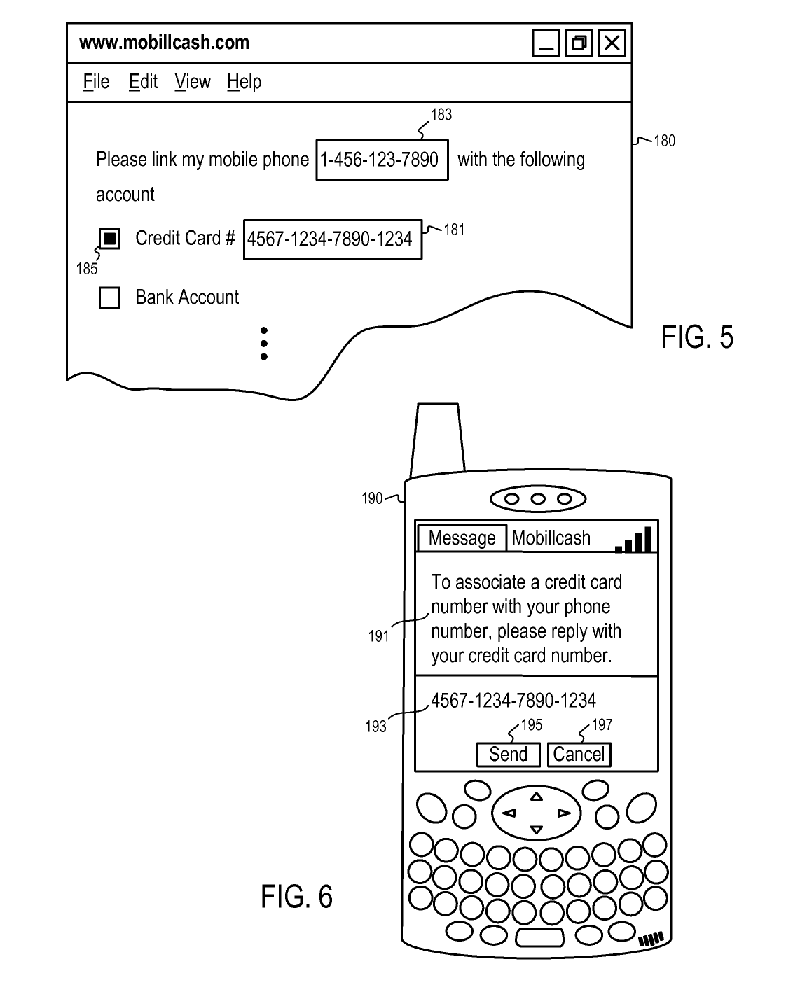

FIG. 5 illustrates a user interface to associate an account with a telephone number according to one embodiment. In FIG. 5, the user interface (180) includes a text field (183) that allows the user to specify the phone number (123) with which the account information (121) provided in the text field (181) is to be associated.

In FIG. 5, the user interface (180) further includes an option list, which allows the user to select various types of accounts, such as credit card accounts, bank accounts, charge card accounts, etc. In the example illustrated in FIG. 5, the checkbox (185) is selected to specify a credit card account.

In some embodiments, the user interface (180) may further present a text field (not shown in FIG. 5) to allow the user to specify an alias for the account information (121) supplied in the text input field (181). For enhanced security, the alias can be used for subsequent communications with the user without revealing the account information (121).

In FIG. 5, the user interface (180) may be presented via a web browser (or a custom application) to submit account information (121) in the text input field (181) from a user terminal (111) to the interchange (101). Alternatively, the account number can be submitted from the mobile phone (117) via a message sent via SMS, WAP, voice mail, or via an interactive voice response (IVR) system.

In one embodiment, the server (113) presents the payment option (185) via an online shopping cart system or a third party checkout system. Alternatively or in combination, the server (113) presents the payment option (185) via a web widget. For example, a web widget may include a program code that is portable and executable within a web page without requiring additional compilation. The web widget allows the user to select the option (185) to pay for the product and/or service without leaving the web page or refreshing the web page. In one embodiment, the interchange (101) provides the web widget to facilitate the payment processing.

FIG. 6 illustrates another user interface to associate an account with a telephone number according to one embodiment. In FIG. 6, the user interface (190) is presented on the mobile phone (117) of the user. The user interface (190) presents a message (191) from the interchange (101) to the mobile phone (117) at the phone number (123). The message (191) prompts the user to submit the account information (121) by providing a reply message (193). The user may select the “send” button (195) to provide the account information (121) for association with the phone number (123) or select the “cancel” button (197) to ignore the prompt.

In one embodiment, the messages (191 and 193) are transmitted to the mobile phone (117) via a short message service (SMS). Alternatively, the messages can be transmitted to the mobile phone (117) via other protocols, such as multimedia message service (MMS), email, instant messaging, WAP, voice mail, voice messages via an interactive voice response (IVR) system, etc.

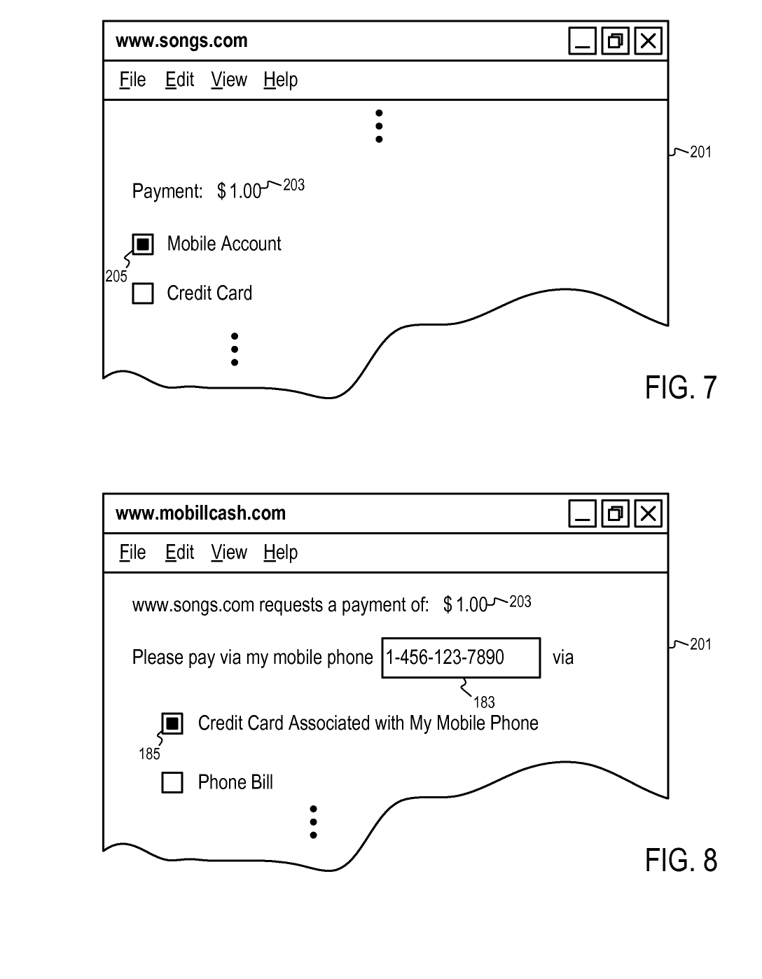

FIG. 7 illustrates a user interface to initiate a payment transaction according to one embodiment. In FIG. 7, the user interface (201) provides an option (205) to request the interchange (101) to process the payment for the amount (203) required to make a purchase from the server (113) of a merchant.

In one embodiment, after the user selects the payment option (205), the server (113) directs the request to the web server of the interchange (101), with a set of parameters to indicate the amount (203), the identity of the merchant, a reference to the purchase, etc. Thus, the user does not have to provide any personal information to the server (113) of the merchant to complete the payment process.

Alternatively, the user may provide the phone number (123) to the merchant to process the payment. Thus, the user does not have to visit the website of the interchange (101) to complete the payment.

FIG. 8 illustrates a user interface to initiate a payment request according to one embodiment, after the payment request is redirected to the website of the interchange (101). In FIG. 8, the user interface (201) includes the identity of the merchant and the amount (203) of the requested payment. The user interface (201) includes a text field (183) to allow the user to provide the phone number (123) to identify the account information (121) via its association with the phone number (123) in the data storage facility (107).

Further, user authentication may be used to reduce false messages to the phone number (123). For example, the user interface (201) may request a PIN for enhanced security. For example, the user may be required to register with the interchange (101) prior to using the services of the interchange (101); and after registering with the interchange (101), the user is provided with the PIN or can created a customized PIN to access the functionality provided by the user interface (201).

Alternatively, the user interface (201) may request an identifier associated with the phone number (123) to initiate the payment transaction. In some embodiments, the user interface (201) requires the user to provide no information other than the phone number (123) in the text field (183) to initiate the transaction.

In FIG. 8, the user interface (201) allows the user to select one option from a plurality of payment options, including paying via the phone bill, and paying via one or more of the accounts identified by the account information (121) associated with the phone number (123) in the data storage facility (107).

In some embodiments, the user interface (201) may present the payment options after authenticating the user (e.g., via a personal identification number or password) for enhanced security.

In some embodiments, the user interface (201) identifies the different accounts represented by the account information (121) by showing aliases of the accounts. The aliases may be previously specified by the user, or be dynamically generated by the interchange (101) based on the types of the accounts and/or portions of the account information (121) (e.g., the first or last few digits of the account number, etc.)

In one embodiment, once the user submits the payment request via the user interface (201), the interchange (101) transmits a confirmation message to the mobile phone (117) according to the phone number (123) provided in the text field (183). In one embodiment, the interchange (101) transmits the confirmation to the mobile phone (117) after the user is authenticated via the user interface (201) to reduce the possibility of unauthorized/unwelcome messages to the mobile phone (117), which may occur when the user intentionally or unintentionally provides an unrelated phone number in the entry box (183).

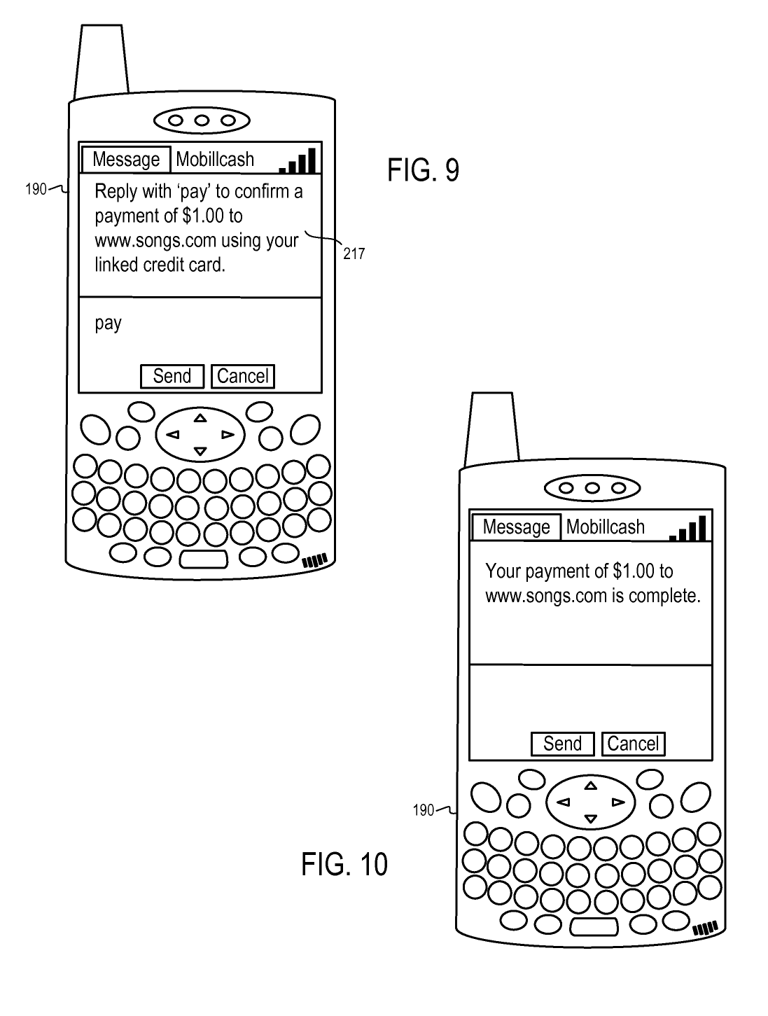

FIG. 9 illustrates a user interface to confirm a payment request according to one embodiment. In FIG. 9, the confirmation message (217) includes the amount (203) of the requested payment and the identity of the payee (e.g., a merchant operating the server (113)).

In one embodiment, the confirmation message (217) includes the instruction to reply with a code, such as a code (e.g., “pay”) provided in the confirmation message (217) as illustrated in FIG. 9.

The presence of the code in the reply message is an indication of the user approving the request; and the requirement for such a code in the reply eliminates false confirmations (e.g., generated via accidental replies or automated replies).

Alternatively or in combination, the requested code may include a PIN associated with the account, and/or a code (not shown) randomly generated and presented in the user interface used to initiate the payment transaction (e.g., user interface (201)).

In some embodiments, the code requested in the text message (217) may be a personal identification number (PIN) associated with the phone number (123). The text message (217) does not include the code; and the knowledge of the code is an indication of the identity of the user. Thus, the use of such a code increases the security of the transaction.

In a further embodiment, the code requested in the text message (217) includes a code that is provided in response to the payment request (e.g., via the user interface (201), not shown in FIG. 8). The code may be generated randomly at the time the request is received via the user interface (201), or when the user interface (201) is presented to the user. The code provided to the user interface (201) can be requested in the reply received from the user interface (190) to indicate that the user who is in possession of the mobile phone (117) has actual knowledge about the payment request submitted via the user interface (201).

After the correct reply is received, the interchange (101) communicates with the account server (125) to electronically charge the user using the account information (121) and pays the payee using the funds collected via communicating with the account server (125). The interchange (101) then notifies the user when the payment transaction is complete.

For example, the interchange (101) may notify the user via a text message to the mobile phone (117), as illustrated in FIG. 10. FIG. 10 illustrates a user interface to confirm the completion of a payment transaction according to one embodiment. No reply to the message that confirms the completion of the payment transaction is necessary. Once the payment transaction is complete, the user would have access to the product purchased via the payment transaction.

In one embodiment, the interchange (101) stores an address of the user associated with the phone number (123). After the completion of the payment transaction, the interchange (101) provides the address to the server (113) of the merchant for the delivery of the purchased product. In some embodiments, the user may provide multiple addresses associated with the phone number (123) and may select one as a delivery address in the confirmation/approve message to the interchange (101). Alternatively, the interchange (101) may receive an address for product delivery from the mobile phone (117) together with the confirmation/approve message and then forward the address to the server (113) of the merchant. Thus, the shipping address of the transaction is verified to be associated with the mobile phone (117). In alternative embodiments, the user may directly provide the shipping address in the website hosted on the server (113) of the merchant.

In other embodiments, the user is provided with the options to pay via the mobile phone bill associated with the phone number (123). The interchange (101) may dynamically calculate a set of premium messages, based on a set of limited number of predetermined prices for premium messages, to match the purchase price. The interchange (101) sends the set of premium messages to the mobile phone (117) at the phone number (123) to collect the funds via the telecommunication carriers to pay for the purchases. Thus, the purchase prices are not limited to the set of predetermined prices for premium messages. In some embodiments, the interchange (101) may send the set of premium messages in a period of time (e.g., a week, a month, a number of mouths, etc.) to spread the payments over the period of time (e.g., to overcome budget limits and/or limits imposed by regulations).

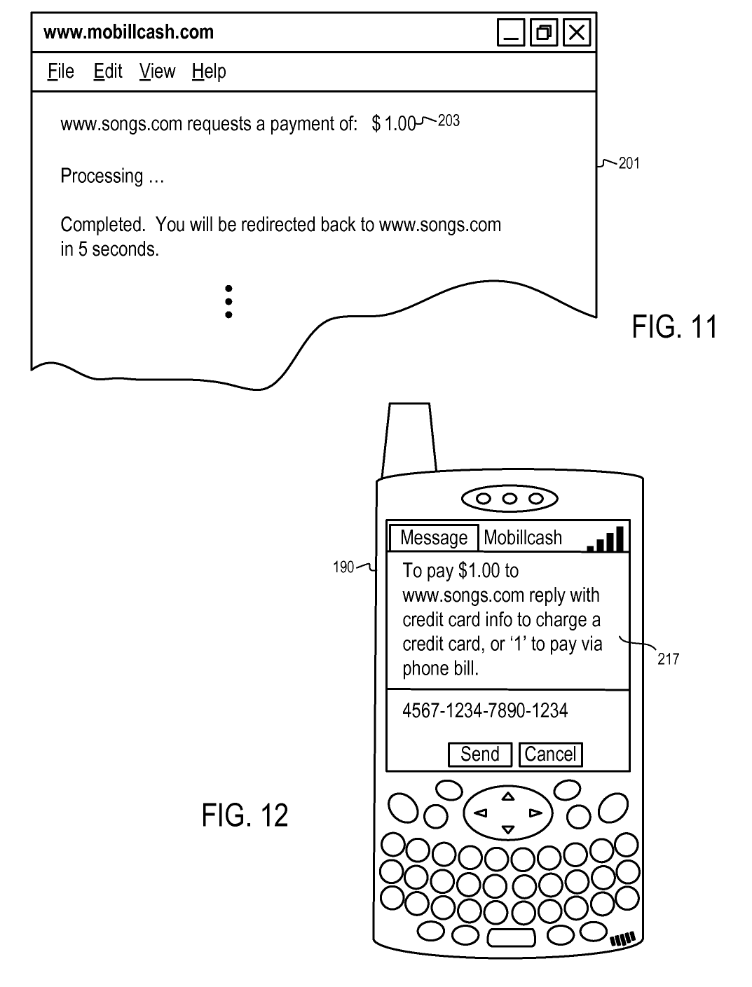

FIG. 11 illustrates a way to redirect a payment confirmation according to one embodiment. For example, after the user submits the payment request to the interchange (101) via the user interface (201) shown in FIG. 8, the interchange (101) may present the user interface (201) illustrated in FIG. 11 to the user. The user interface (201) indicates that the request is being processed; and the user interface (201) is periodically updated to show progress. Once the payment transaction is completed, the user interface (201) provides a confirmation message and may automatically redirect the user back to the website of the payee (e.g., to access the purchased products or services).

In one embodiment, the user is required to provide the approval in response to the confirmation message (217), as illustrated in FIG. 9, within a predetermined period of time. If the user fails to provide the approval from the mobile phone (117) within the predetermined period of time, the payment request may be rejected; and the user interface (201) may present a message indicating the failure and then redirect the user back to the website of the payee.

In some embodiments, instead of redirecting the user back to the website of the payee after the expiration of a predetermined period of time (e.g., after the failure of the payment process, or after the completion of the payment), the user interface (201) may provide a link to the website of the payee to allow the user to manually select the link to go back to the website of the payee to continue the process at the website of the payee.

FIG. 12 illustrates a user interface to receive payment options according to one embodiment. In FIG. 12, the interchange (101) sends a message (217) to the mobile phone (117) to provide a number of options to the user. The message (217) identifies the amount (203) of the requested payment and the identity of the payee (e.g., a merchant operating the server (113)) and asks the user to approve the payment request via a reply that contains a selected payment option.

In FIG. 12, the user may reply with the code “1” to approve the payment request and to pay via the phone bill of the mobile phone (117). Alternatively, the user may reply with the credit card information to charge the payment to a credit card, as illustrated in FIG. 12.

In one embodiment, if the user provides credit card account information in the approval message, the credit card account information is stored and associated with the phone number (123) in the data storage facility (107). Thus, in subsequent approval messages, the user does not have to supply the same information again.

For example, the data storage facility (107) may store account information for each of a plurality of account types (e.g., Visa, MasterCard, checking, savings, etc.) Thus, each of the accounts can be identified to the user via the account type in the confirmation message, without revealing the details of the account information.

For example, the interchange (101) may combine the name of the financial institutions and the type of accounts to generate aliases for the account information.

In some embodiment, the user may define the aliases for the account information by supplying the aliases with the account information (121) for association with the phone number (123).

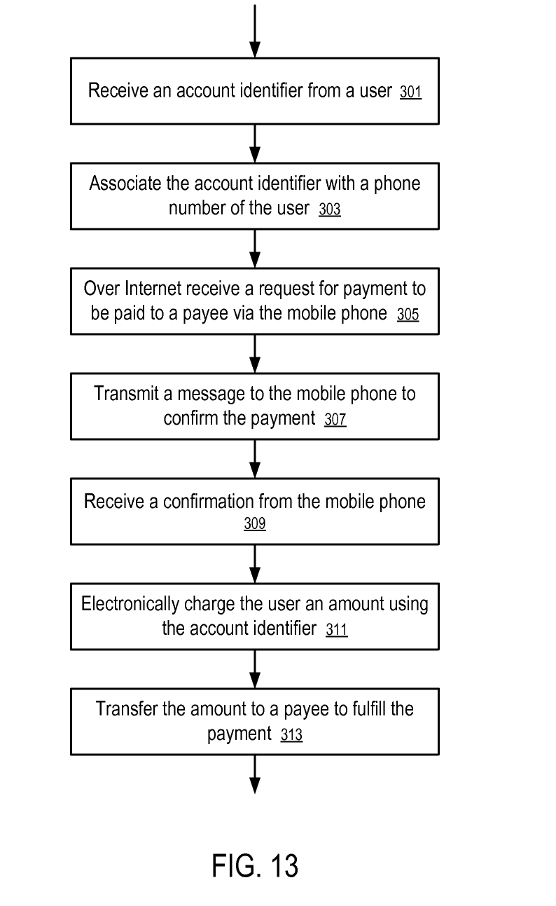

FIG. 13 shows a method to process an online payment according to one embodiment. In FIG. 13, the interchange (101) receives (301) an account identifier (e.g., 121) from a user and associates (303) the account identifier with a phone number (123) of the user in the data storage facility (107). Over the Internet the interchange (101) subsequently receives (305) a request for payment to be paid to a payee via the mobile phone (117) identified by the phone number (123). In response to the request, the interchange (101) transmits (307) a message (217) to the mobile phone (117) to confirm the payment.

After receiving (309) a confirmation or approval from the mobile phone (117) for the payment, the interchange (101) electronically charges (311) the user an amount using the account identifier (e.g., via communicating with the account server (125) using the account identifier). The interchange (101) then transfers (313) the amount to a payee to fulfill the payment.

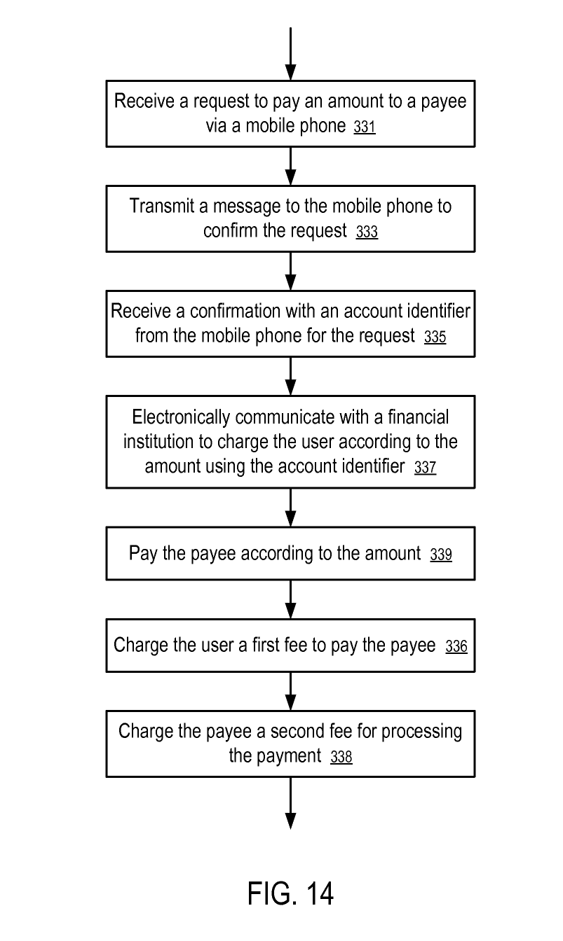

FIG. 14 shows another method to facilitate a payment transaction according to one embodiment. In FIG. 14, the interchange (101) receives (331) a request to pay an amount to a payee via a mobile phone (117). The interchange (101) transmits (333) a message (217) to the mobile phone (117) to confirm the request via the converter (131) corresponding to the controller (115) of the mobile phone (117).

After the interchange (101) receives (335) a confirmation with an account identifier (e.g., 121) from the mobile phone (117) for the request, the interchange (101) electronically communicates (337) with a financial institution to charge the user the specified amount using the account identifier. The interchange (101) pays (339) the payee according to the amount, optionally charges (336) the user a first fee to pay the payee, and optionally charges (338) the payee a second fee for processing the payment.

In one embodiment, the users are given an incentive to provide the account information (121) for electronic payments via the account servers (125). For example, the interchange (101) may charge a lower fee for fulfilling payment requests via the account server (125) than for fulfilling payments requests via the phone bill. For example, the interchange (101) may offer rebates, discounts, etc. to the users who provide the account information (121). In some embodiments, the interchange (101) can complete a payment process via the account server (125) with fewer restrictions than via the phone bill.

In one embodiment, the merchant may specify the second fee. Different merchants may offer different percentages of the purchase prices as the second fee; and the interchange (101) may calculate the first fee based on the second fee offered by the merchant, by deducting the second fee from the total fees to be charged (e.g., fees charged by the telecommunication carrier for collecting the funds via the mobile phone bill associated with the phone number (123) and/or the fees charged by the interchange (101) for processing the payments). Since the first fee is charged to the customer (e.g., the purchaser of products and services), the cost to the customer can vary based on the selection of the merchant. For the same purchase prices, the first fee (and thus the cost to the customer) may be different for purchases made via different merchants, because the merchants may offer different percentage of the purchase price as the second fee. In some embodiments, the first and second fees include both fees charged by the telecommunication carrier for collecting the funds via the mobile phone bill/account associated with the phone number (123) and the fees charged by the interchange (101) for processing the payments. In some embodiments, the first fee includes the fees charged by the telecommunication carrier but no fees charged by the interchange (101). In some embodiments, the second fee includes the fees charged by the telecommunication carrier but no fees charged by the interchange (101). In some embodiments, the first fee and/or the second fee do not include the fees charged by the telecommunication carrier. In some embodiments, the first fee is not charged; and in other embodiments, the second fee is not charged.

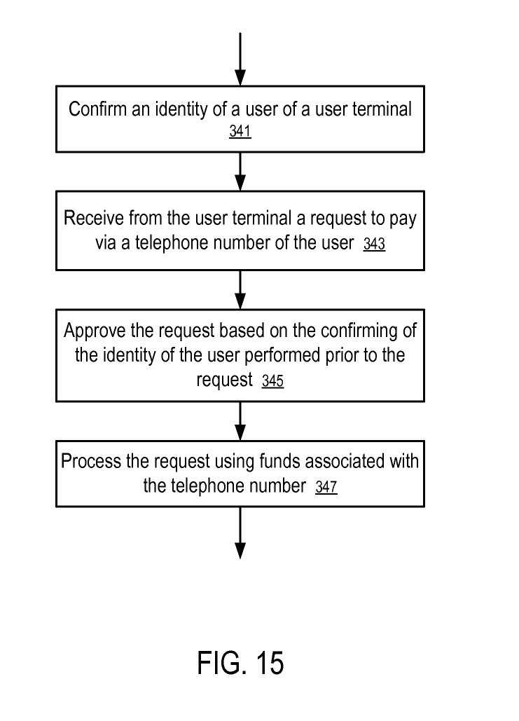

FIGS. 15-18 show methods to approve a payment transaction according to some embodiments.

In FIG. 15, after the interchange (101) confirms (341) an identity of a user of a user terminal (111), the interchange (101) receives (343) from the user terminal (111) a request to pay via a phone number (123) of the user. In one embodiment, the interchange (101) confirms the identify of the user of the user terminal (111) and/or associates the identity of the user of the user terminal (111) with the phone number (123) of the mobile phone (117) prior to the user submitting a request to pay via the phone number (123). Thus, communications with the mobile phone (117) at the phone number (123) for the confirmation and/or approval of the request does not have to take place between the request and the payment operation; and thus the delay between the request and the payment operation can be reduced.

For example, the user terminal (111) may include a web browser; and the user may log into a web server of the interchange (101) using the web browser. The interchange (101) may prompt the user via the web browser running on the user terminal (111) to provide the phone number (123) and a password associated with the phone number (123). After verifying the password, the user is logged into a session tracked by the web browser on the user terminal (111); and the web browser running on the user terminal (111) is associated with the phone number (123).

In one embodiment, the interchange (101) further communicates with the mobile phone (117) at the phone number (123) to complete the verification process. For example, the interchange (101) may send a one-time verification code to the mobile phone (117) at the phone number (123) and request the user to provide the correct one-time verification code back via the user terminal (111) to verify the association between the user terminal (111) and the phone number (123). Alternatively, the interchange (101) may provide the one-time verification code to the user terminal (111) and instruct the user to communicate the code back to the interchange (101) via the mobile phone (117) at the phone number (123). Alternatively, after the user logs in using the user terminal (111), the interchange (101) may send a message to the mobile phone (117) to request a reply from the mobile phone (117) at the phone number (123) within a predetermined period of time to validate the session. In some embodiments, after the user provides the phone number (123) using the user terminal (111) to the interchange (101), the user is instructed to provide the password via the mobile phone (117) to complete the log in process.

In one embodiment, the user terminal (111) tracks the session. For example, the user terminal (111) may use a web browser to track the session via information maintained by the web browser (e.g., cookies). Alternatively or in combination, the interchange (101) may track the session by maintaining information on the data storage facility (107). For example, after the user completes the log in process, the interchange (101) may identify the user terminal (111) via identifiers such as Internet address, Media Access Control address (MAC address), a different phone number (e.g., when the user terminal is a different cell phone), or other software or hardware identification number associated with the user terminal (111), such as a digital certificate; and the interchange (101) may associate the phone number (123) with such identifiers until the expiration of a predetermined time period, or after the user signals an end of the session using the user terminal (111) or using the mobile phone (117) at the phone number (123). In one embodiment, the interchange (101) associates a plurality of identifiers of the user terminal (111) with the phone number (123) for the session. When at least one of the identifiers of the user terminal (111) is changed, the interchange (101) may terminate the session automatically.

In FIG. 15, after the user terminal (111) submits the request to pay via the phone number (123), the interchange (101) approves (345) the request based on the confirming of the identity of the user performed prior to the request and processes (347) the request using funds associated with the phone number (123). For example, the interchange (101) may transmit premium messages, via a corresponding converter (131), to a mobile phone (117) at the phone number (123) to collect the funds, or receive premium messages from a mobile phone (117) at the phone number (123) to collect the funds. For example, the interchange (101) may determine the account information (121) (e.g., an account identifier, such as a credit card number, a bank account number, a debit card number, etc.) stored and associated with the phone number (123) on the data storage facility (107) of the interchange (101) to charge the user using the account information (121).

In one embodiment, in response to the payment request from the user terminal (111), the interchange (101) may send a notification message to the mobile phone (117) at the phone number (123). The user is not required to provide a reply to complete the payment process. However, the user of the mobile phone (117) is provided with the option/opportunity to reply and report a fraudulent use, or to cancel the request (e.g., within a predetermined period of time).

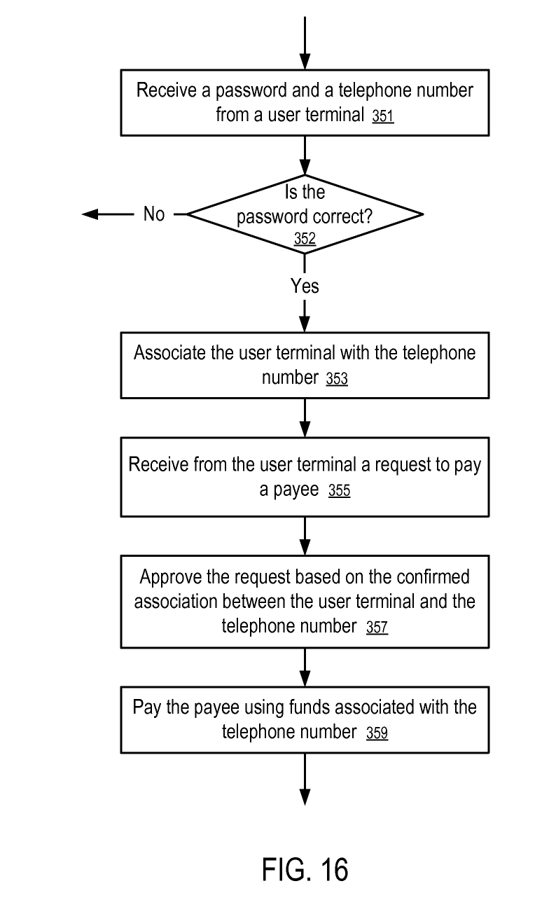

In one embodiment, the data storage facility (107) stores a password associated with the phone number (123) for authentication. In FIG. 16, after the interchange (101) receives (351) a password and a phone number (123) from a user terminal (111), the interchange (101) determines (352) whether the received password is the correct password for the phone number (123). If the received password is the correct password for the phone number (123), the interchange (101) associates (353) the user terminal (111) with the phone number (123) in the data storage facility (107). If, during the time period in which the user terminal (111) is associated with the phone number (123), the interchange (101) receives (355) from the user terminal (111) a request to pay a payee (e.g., via the user interface (201) illustrated in FIG. 8), the interchange (101) may approve (357) the request based on the confirmed association between the user terminal (111) and the phone number (123) and pay the payee using funds associated with the phone number (123), without requiring a confirmation via the mobile phone (117) at the phone number (123). In some embodiments, after the user terminal (111) submits the phone number (123) to the interchange (101), the interchange (101) may request the password from the mobile phone (117) at the phone number (123).

In one embodiment, during the time period in which the user terminal (111) is associated with the phone number (123), the interchange (101) may automatically provide the phone number (123) in the text field (183) in the user interface (201) for submitting a payment request, illustrated in the FIG. 8, based on the association between the user terminal (111) and the phone number (123). The phone number (123) can be provided by the interchange (101) in the text field (183) as a default input. Alternatively, the interchange (101) may not provide the phone number (123) and may require the user to enter the phone number (123) in the text field (183) for enhanced security. In some embodiments, the interchange (101) may dynamically determine whether or not to present the phone number (123) in the text field (183) based on a transaction pattern associated with the phone number (123). For example, if the current request matches the pattern, the interchange (101) presents the phone number (123) as the default input to simplify user interactions; otherwise, the interchange (101) does not provide the phone number (123) in the text field (183) for enhanced security.

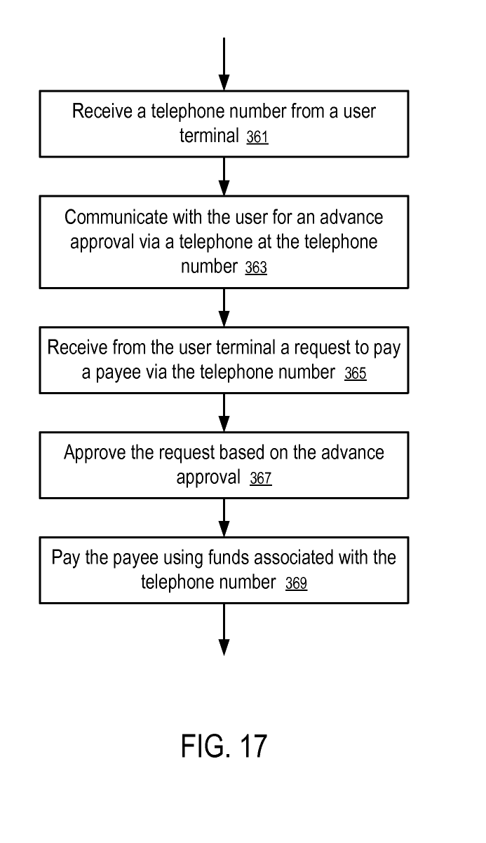

In FIG. 17, after the interchange (101) receives (361) a phone number (123) from a user terminal (111), the interchange (101) communicates (363) with the user for an advance approval for the user terminal (111) via a mobile phone (117) at the phone number (123). For example, the interchange (101) may communicate with the mobile phone (117) at the phone number (123) for the advance approval and/or communicate with the user terminal (111) to confirm a password associated with the phone number (123).

In one embodiment, the advance approval is specific for the user terminal (111); and the interchange (101) stores identifiers of the user terminal (111) with the advance approval. For example, the interchange (101) may communicate with the user terminal (111) and/or the mobile phone (117) to associate the user terminal (111) with the phone number (123) for the advance approval of one or more subsequent payment requests.

In some embodiments, the advance approval is not limited to a particular user terminal (111). For example, the user may directly use the mobile phone (117) at the phone number (123) to communicate the advance approval to the interchange (101) without having to identify the user terminal (111). Alternatively, the user may use a particular user terminal (111) to initiate the communications with the interchange (101) for the advance approval without limiting the advance approval to subsequent payment requests for the same particular user terminal (111).

In one embodiment, the advance approval is associated with the phone number (123) on the data storage facility (107). When a request to pay via the funds associated with the phone number (123) is received, the advance approval associated with the phone number (123) is identified and applied by the interchange (101). The user does not have to explicitly identify the advance approval in making the payment request.

In one embodiment, the interchange (101) may assign an identification code for the advance approval for enhanced security. The user may use the identification code in the payment request to explicitly identify the advance approval.

In one embodiment, the advance approval specifies a time limit for the expiration of the approval, a budget amount for one or more payment requests, a limit on the types of permitted products and/or services, a time window for permissible payment requests, a frequency for permissible payment requests, and one or more limits based on certain characteristics of the payees (e.g., web addresses, countries, categories, etc.).

In one embodiment, the advance approval may specify some limits on the permissible user terminals (111). For example, the advance approval may limit the advance approval to user terminals located with certain geographic areas. The interchange (101) may determine the geographic areas of the user terminals (111) based on the IP addresses of the user terminals (111), the access points for wireless local area communications, the base stations for cellular communications, etc.

After the advanced approval is associated with the phone number (123), the interchange (101) may receive (365) from the user terminal (111) a request to pay a payee via the phone number (123). Based on the advance approval the interchange (101) may approve (367) the request and pay (369) the payee using funds associated with the phone number (123), without requiring a confirmation message from the user via communications with the mobile phone (117) at the phone number (123).

In some embodiments, the interchange (101) may use the transaction history (127) to determine whether or not to require a confirmation message from the user via communications with the mobile phone (117) at the phone number (123). The transaction history (127) may include a number of records of prior confirmed/approved payment requests.

For example, based on the records of prior payment requests the interchange (101) may determine a payment pattern for the phone number (123), such as a list of frequently used user terminals (111) for the phone number (123), a range for typical payment amounts, a time period of a day within which typical payment requests are received for the phone number (123), a list of frequently used payees paid via the phone number (123), a list of categories of services and/or products frequently paid via the phone number (123), a recent payment requested confirmed within a predetermined period of time, etc.

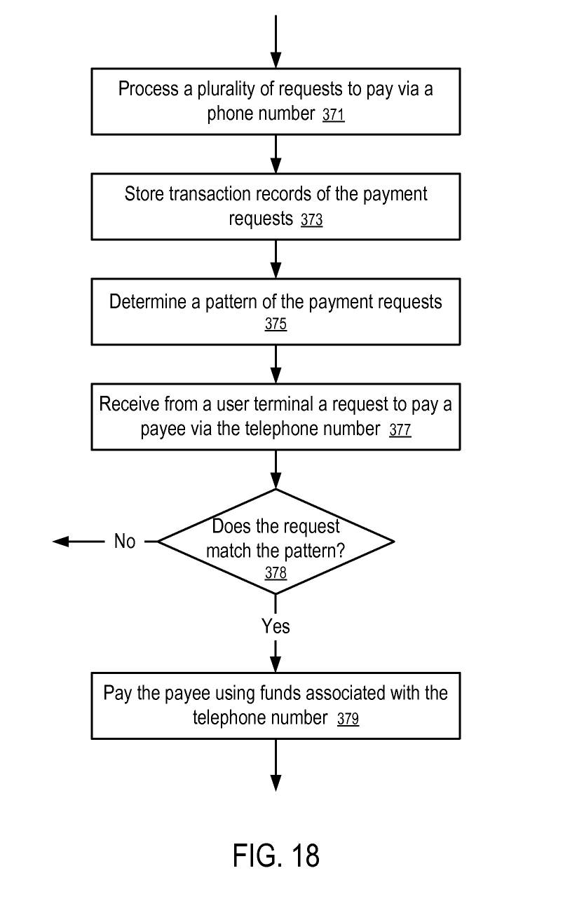

In FIG. 18, the interchange (101) processes (371) a plurality of requests to pay via a phone number (123). The interchange (101) processes (371) the requests via communicating with the mobile phone (117) at the phone number (123). For example, the interchange (101) may send a message to the mobile phone (117) at the phone number (123) and request a reply to the message from the mobile phone (117). For example, the interchange (101) may request a PIN from the mobile phone (117) at the phone number (123) to confirm the requests. For example, the interchange (101) may send one-time codes representing the requests to the mobile phone (117) or receive one-time codes representing the requests from the mobile phone (117).

The interchange (101) stores (373) transaction records of the payment requests and determines (375) a pattern of the payment requests.

Subsequently, when the interchange (101) receives (377) from a user terminal (111) a request to pay a payee via the phone number (123), the interchange (101) determines (378) whether the request matches the pattern. If the request matches the pattern, the interchange (101) pays (379) the payee using funds associated with the phone number (123), without requiring a confirmation communicated via the mobile phone (117) at the phone number (123) to speed up the payment process. The interchange (101) may send a notification to the mobile phone (117) at the phone number (123), without requiring a reply prior to making the payment.

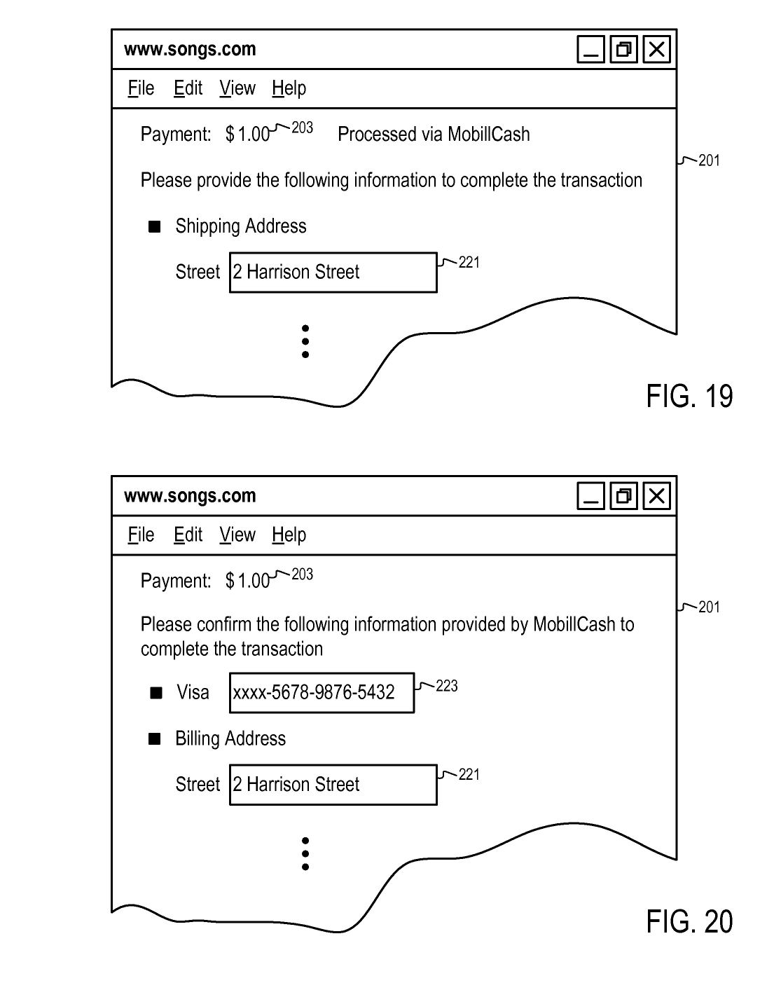

FIG. 19 shows a user interface to provide user information in connection with payment processing according to one embodiment. In FIG. 19, the user interface (201) is presented after the interchange (101) finishes processing a payment request. For example, the user interface (201) in FIG. 19 may be displayed after the user is redirected from the website of the interchange (101) to the website of the payee on the server (113) (e.g., redirected from the user interface (201) illustrated in FIG. 11).

In one embodiment, the server (113) uses the user information (129) received from the interchange (101) to fill in the entry boxes (e.g., 221) as the default values to assist the user in the transaction. For example, the transaction may require a shipping address (221) and/or other information, such as shipping preferences, billing addresses, etc.

In one embodiment, the user information (129) is provided from the interchange (101) to the server (113) during the interchange (101) redirecting the user to the server (113). For example, the user information (129) can be embedded or encoded in the uniform resource locator (URL) for redirecting the user to the server (113). In another embodiment, the server (113) queries the interchange (101) in relation with the transaction to obtain the user information (129). For example, the server (113) may access an application programming interface (API) or a web service of the interchange (101) to obtain the user information (129).

In some embodiments, the interchange (101) operates in the background. After the user provides the phone number (123) to the server (113), the server (113) accesses an application programming interface (API) or a web service of the interchange (101) to process the payment and/or obtain the user information (129). The interchange (101) may secure the access to the information via communications with the mobile phone (117) at the phone number (123) in response to the server (113) accessing the API or web service of the interchange (101). Alternatively or in combination, the interchange (101) may secure the access to the information based on advance approval from the mobile phone (117), and/or based on the transaction patterns determined from the transaction history (127).

In some embodiments, the interchange (101) does not obtain funds from the user to pay the payee on behalf of the user of the mobile phone (117). Instead, the interchange (101) may provide the account information (121) to the server (113) to allow the server (113) to charge the user using the account information (121), as illustrated in FIG. 20.

FIG. 20 shows a user interface to provide user information to facilitate payment processing according to one embodiment. In FIG. 20, the user interface (201) is presented after the interchange (101) confirms that the user of the mobile phone (117) approves the transaction and after the interchange (101) provides the account information (121) to the server (113).

In one embodiment, after obtaining the account information (121) from the interchange (101), the server (113) may present the account information (121) in a form back to the user for confirmation and/or modification, as illustrated in FIG. 20.

For example, in FIG. 20, the account type (e.g., visa) and the account number are presented to the user. To improve security, the entry box (223) shows only a portion of the account number and hides the remaining portion of the account number. In some embodiments, the user is required to provide the portion of the account number that is hidden in the entry box (223); and the server (113) matches the portion obtained from the interchange (101) and the portion obtained from the user via the entry box (223) to determine whether to accept the request.

In some embodiments, the interchange (101) may provide only a portion of the account number (e.g., the first or last portion of the account number); and the user interface (201) requires the user to complete the remaining portion of the account number. In some embodiments, the interchange (101) does not provide the account number; and the user interface (201) requires the user to provide the account number.

In one embodiment, the interchange (101) also provides other information, such as billing address (221), shipping address, etc. Such information can be displayed in the user interface (201) as the default values for user confirmation. Thus, if the user accepts the default values, the user does not have to provide manual input, which provides convenience and improves user experience.

In some embodiments, the server (113) may directly process the payment using the account number and/or complete the transaction using the user information (129) without presenting it to the user. For example, after obtaining the account information (121) from the interchange (101), the server (113) may communicate with the account server (125) to charge the user for the purchased products and/or services; and after successfully charging the user, the server (113) may further present the shipping information to the user (e.g., as illustrated in FIG. 19), without showing the account information (121). In one embodiment, the user stores a preference option on the data storage facility (107) to indicate whether to request the interchange (101) to pay the servers (113) on behalf of the user, or to request the interchange (101) to release the account information (121) to the server (113) when needed. In one embodiment, the user may specify such a preference when the user confirms a payment request via the mobile phone (117) having the phone number (123).

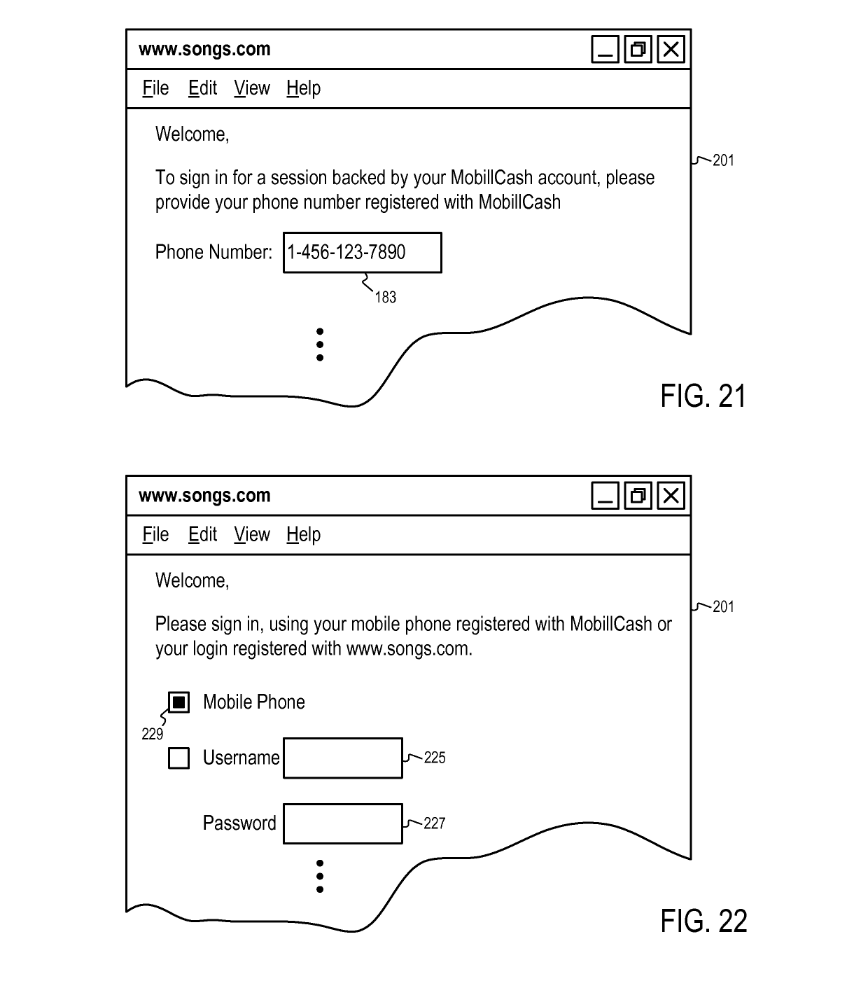

FIGS. 21 and 22 illustrate user interfaces for authentication according to some embodiments.

In FIG. 21, the user interface (201) allows the user to provide the phone number (123) in the entry box (183) to start an authenticated session. In one embodiment, after the server (113) receives the phone number (123) from the entry box (183), the server (113) requests the interchange (101) to confirm the identity of the user via the mobile phone (117).

For example, the interchange (101) may transmit an SMS message (or a voice message, or an email) to the mobile phone (117) at the phone number (123). When an appropriate reply to the SMS message is received back from the mobile phone (117), the interchange (101) determines that the user identity is confirmed.

For example, the interchange (101) may provide a one time code to the user (e.g., via the server (113) or via the mobile phone (117)) and request the user to provide the one time code back to the interchange (101) via the mobile phone (117) (e.g., via an SMS message, via a voice call, via a web request from the mobile phone (117) having the phone number (123), etc.). In some embodiments, the server (113) may generate the one time code, and requests the user to submit the code to the interchange (101) to complete the authentication process. The interchange (101) and/or the server (113) may determine if the code received from the mobile phone (117) matches the code provided (e.g., the code generated by the server (113) or the code generated by the interchange (101)).

In some embodiment, the one time code may be provided to the mobile phone (117) at the phone number (123) and the user is required to provide the one time code back to the server (113) and/or the interchange (101) to complete the authentication process.

In one embodiment, the server (113) (or the interchange (101)) may request a correct password or personal identification number (PIN), transmitted from the mobile phone (117) having the phone number (123) via the interchange (101), to complete the authentication process.

In one embodiment, the authentication process serves as an advance approval for payment requests occurring in the session. For example, after the authentication process, the web session on the user terminal (111) is associated with the phone number (123); and before the web session is timed out (or the user signs out of the web session), payment requests can be processed using the phone number (123) without having to provide the phone number (123) again from the user terminal (111) and/or to receive a communication from the user via the mobile phone (117) at the phone number (123) to confirm the payment requests.

In one embodiment, the web session authenticated via the interchange (101) is associated with a particular website of a merchant or service provider. For example, the authenticated web session can be used as an advanced approval for the particular website but not for a different website. In another embodiment, the web session authenticated via the interchange (101) is associated with the user terminal (111) and is applicable to different websites. For example, the authenticated web session initiated via one website may be used as an advance approval for other websites visited during the session.

In one embodiment, the user information (129) includes login credentials of the user with the server (113). When the user entity is confirmed with the mobile phone (117) having the phone number (123), the login credentials of the user can be provided from the data storage facility (107) to the server (113) to start an authenticated session, as illustrated in FIG. 22.

In FIG. 22, the user may select the option (229) to sign in via the mobile phone (117). Once the mobile phone option is selected in the user interface (201) illustrated in FIG. 22, the user is directed to a website of the interchange (101), which obtains the mobile phone number (123) from the user. After communicating with the mobile phone (117) at the phone number (123) to confirm the login request, the interchange (101) provides the corresponding login credentials of the user to server (113) to start an authenticated session on the server (113).

In one embodiment, after the server (113) obtains the login credentials (e.g., username and/or password) from the interchange (101), the server (113) may present the information in entry boxes (225 and 227) as default values, allowing the user to sign in by simply confirming the request. For security, the password may be presented as a string of hidden characters. The user may confirm the values and/or modify the values to sign into an authenticated session that is associated with both the server (113) and the interchange (101).

In one embodiment, after the server (113) obtains the login credentials (e.g., username and/or password) from the interchange (101), the server (113) may sign the user in directly without presenting the login credentials back to the user. Thus, the user does not have to provide additional input to the server (113) to sign in, after the request is confirmed via the interchange (101).

In one embodiment, the communications to confirm the user identity may involve communications via the server (113). For example, a one time code may be provided or received via the server (113) and the mobile phone (117) having the phone number (123). In some embodiments, the user is required to submit the password via the mobile phone (117) to sign into the server (113) for a web session running on the user terminal (111).

In one embodiment, the user may use the entry boxes (225 and 227) of the user interface (201), shown in FIG. 22, to sign into a session at the server (113) directly, without going through the interchange (101). During the session, when the payment is required, the user may provide the mobile phone number (123) to confirm the payment request via the mobile phone (117).

Alternatively, during the session the server (113) may identify the user by the login information to the interchange (101), which then looks up the phone number (123) via matching the login information and then confirming the payment request via communications with the mobile phone (117) at the phone number (123). Thus, during the session the user does not have to separately identify the phone number (123) in a payment request.

In one embodiment, during the session, after the first payment request is confirmed via communications with the mobile phone (117), the session is associated with both the server (113) and the interchange (101); and subsequent payment requests in the session may not require confirmation via the mobile phone (117).

In some embodiments, the user information (129) may not include login credentials for the server (113). After the interchange (101) confirms the identity of the user via the mobile phone (117), the interchange (101) does not provide login credentials to the server (113); however, the interchange (101) may indicate to the server (113) that the identity of the user is confirmed and that the user is associated with the phone number (123); and the server (113) may start a session for an account assigned to the phone number (123). In some embodiments, the interchange (101) may not even give the phone number (123) to the server (113); instead, a token (e.g., a user identifier) representing the phone number (123) may be used to identify the user to the server (113), and the token can be used in subsequent communications between the server (113) and the interchange (101) to identify the phone number (123) and the associated user.

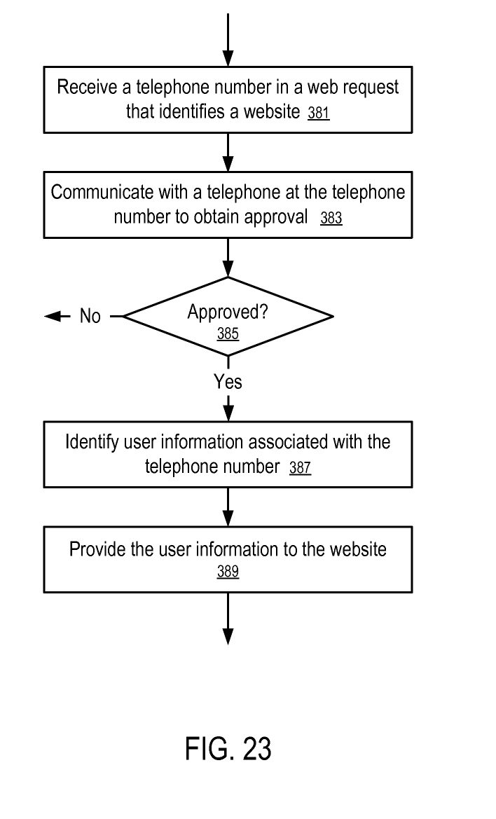

FIG. 23 shows a method to provide information according to one embodiment. In FIG. 23, a phone number (123) is received (381) in a web request that identifies a website. The web request may be forwarded from a server (113) to the interchange (101), after the user provides the phone number (123) to the server (113). Alternatively, the web request may be received directly in the interchange (101) from the user terminal (111), after the server (113) forwards the request to the interchange (101). In some embodiments, the server (113) sends the web request to the interchange (101) via an application programming interface (API) or a web service.

Using the phone number (123), the interchange (101) communicates (383) with a mobile phone (117) at the phone number (123) to obtain approval from the user. In some embodiments, the interchange (101) obtains the advance approval prior to the web request. The user information (129) may be an address of the user, a login credential of the user at a third party website, or financial account information of the user, such as a credit card number, a debit card number, and a bank account number, etc.

In one embodiment, to obtain the approval the interchange (101) transmits a message to the mobile phone (117) at the phone number (123) and receives a reply to the message back from the mobile phone (117). In one embodiment, the message and reply are transmitted via short message service (SMS).

In one embodiment, to obtain the approval the interchange (101) transmits a first code to the mobile phone (117) at the phone number (123), provides a web page in response to the web request, and receives a second code in the web page in the server (113). The interchange (101) marches the first code with the second code to determine whether to approve the providing of the user information (129) to the third party website.

In one embodiment, to obtain the approval the interchange (101) provides a first code in a web page in response to the web request, receives a second code from the mobile phone (117), and matches the first code with the second code to determine whether to approve the providing of the user information (129) to the third party website.

In one embodiment, to obtain the approval the interchange (101) receives, from the mobile phone (117) at the phone number (123), a first personal identification number (PIN) (or password) and matches the first PIN with a second PIN associated with the phone number (123) in the data storage facility (107) to determine whether to approve the providing of the user information (129) to the third party website.

In FIG. 23, if the web request is approved (385), the interchange (101) identifies (387) user information (129) associated with the phone number (123) and provides (389) the user information (129) to the website.

In one embodiment, the interchange (101) further makes a payment to the third party website in accordance with the web request, using funds associated with the phone number (123) of the user. The interchange (101) may collect the funds via at least one premium message originated from or terminated at the mobile phone (117) at the phone number (123), or by charging the user using the account information (121) associated with the phone number (123).

In one embodiment, advertisements are sent to mobile phones to enable the users of the mobile phones to purchase items via the interchange (101). For example, a merchant can send an advertisement message via wireless technology (e.g., cellular telecommunications, wireless wide area network (WWAN), wireless local area network (WLAN), wireless personal area network (WPAN), Bluetooth) to the mobile phone (117) of the user. For example, the advertisement can be selected and sent to the mobile phone (117), based on the location of the mobile phone (117), when the user approaches the merchant. The user can purchase the item presented on the advertisement via the interchange (101).

In one embodiment, merchants can send out mobile messages to alert users about deals on their sites. If the user simply replies to that message, the interchange (101) can bill the purchase to the mobile phone (117).

In some embodiments, the interchange (101) stores the user information (129) in the data storage facility (107), such as the default address of the user which can be used to facilitate the completion of the transaction without further input from the user. In some embodiments, the user may also specify the shipping address in the reply to the advertisement message.

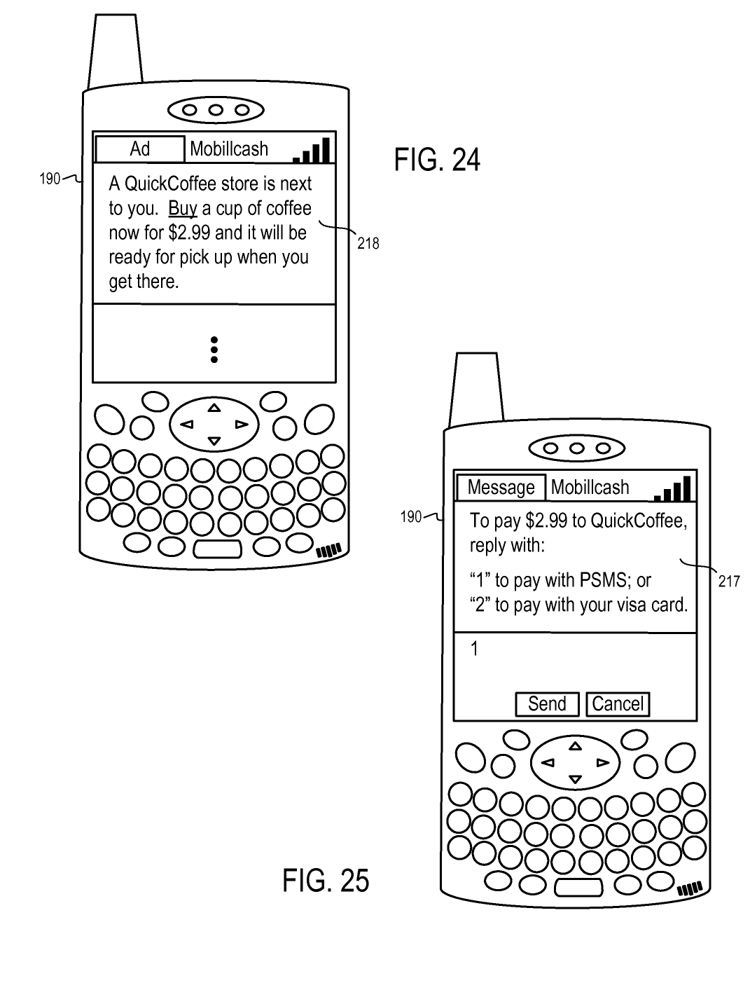

FIG. 24 shows an advertisement on a mobile phone according to one embodiment. In FIG. 24, the advertisement message (218) is presented on the mobile phone (117) at the phone number (123) when the mobile phone (117) is near the seller of the item presented in the advertisement.

In one embodiment, the mobile phone (117) determines its own location and transmits the location to a server (113) to obtain location dependent services; and the advertisement message (218) is transmitted to the mobile phone (117) in response to the location of the mobile phone (117). In another embodiment, a location server monitors the location of the mobile phone (117) based on wireless signals emitted from the mobile phone (117). A server (113) transmits the advertisement message (218) to the mobile phone (117) when the location and/or the preference of the user of the mobile phone (117) meet a set of requirements.

In one embodiment, the advertisement message (218) is transmitted from the server (113) of a merchant. For example, a location-based service provider may notify the server (113) of the merchant about the presence of the mobile phone (117) near the store of the merchant. In another embodiment, a centralized server (113) is configured to send the advertisement message (218) to the mobile phone (117) on behalf of the merchant.

In FIG. 24, the advertisement message (218) includes a “Buy” link, which can be selected by the user of the mobile phone (117) to generate a purchase request to buy the item presented in the advertisement message (218). In one embodiment, the selection of the “Buy” link causes the mobile phone (117) to send a text message, to submit a web or WAP request, or to send one or more premium messages to the interchange (101) (or the server (113) of the advertiser/seller).

In one embodiment, the purchase request from the mobile phone (117) is sent to the interchange (101). The purchase request includes an indication of the advertisement, which allows the interchange (101) to determine information about the purchase, such as the item to be purchased, the seller, the price, the quantity, etc. The interchange (101) then purchases the item as requested on behalf of the user, using funds associated with the phone number (123).

In another embodiment, the purchase request from the mobile phone (117) is sent to the server (113) of the merchant, which determines the amount for the purchase and communicates with the interchange (101) to request a payment.

In one embodiment, the purchase request also includes the phone number (123) of the mobile phone (117) to identify the buyer. The interchange (101) uses the funds associated with the phone number (123) to pay for the purchases. In one embodiment, the phone number (123) of the mobile phone (117) on which the purchase request is generated is added to the purchase request to identify the buyer. In one embodiment, the phone number (123) of the mobile phone (117) to which the advertisement message (218) is sent is embedded in the advertisement message (218) and included in the purchase request.

In one embodiment, both the phone number to which the advertisement message (218) is sent and the phone number at which the purchase request is generated are included in the purchase request. The interchange (101) may skip the operations to confirm the transaction with the mobile phone (117) at the phone number (123), when the phone number to which the advertisement message (218) is sent is the same as the phone number at which the purchase request is generated, when the purchase request (177) is generated via a reply message, and/or when the purchase matches a pattern of prior transactions determined based on the transaction history (127).

In some embodiments, the advertisement message may include the offer of a plurality of items. The user may select and purchase a subset of the items by specifying the selected items. In some embodiments, the user can further specify selected options for the purchased items and/or the quantities of the items to be purchased.

In one embodiment, the advertisement message is encoded such that when the advertisement message is selected (or replied to), a request is transmitted from the mobile phone (117) to the interchange (101), which identifies the items purchased and the seller of items, and purchases the items from the seller on behalf of the user. The interchange (101) uses the funds associated with the phone number (123) of the mobile phone (117) to pay for the purchases.

For example, the interchange (101) may send premium messages to the mobile phone (117) at the phone number (123) to collect funds for the purchase via the telecommunication carrier of the mobile phone (117). For example, the interchange (101) may send a message to the mobile phone (117) to instruct the user to send premium messages to the interchange (101) to provide the funds for the purchase. In some embodiments, the advertisement message is configured to cause the mobile phone (117) to send the premium message to the interchange (101) when the items in the advertisement message are selected for purchase. In some embodiments, the interchange (101) uses the account information (121) associated with the phone number (123) on the data storage facility (107) to communicate with the account server (125) to obtain the funds from the account of the user for the purchase.

In some embodiments, the advertisement message (218) is sent to the mobile phone (117) via short message service (SMS). The user may reply to the advertisement message (218) to generate the purchase request. In one embodiment, the advertisement message (218) is configured to have the reply sent to the interchange (101). Alternatively, the advertisement message (218) is configured to have the reply sent to the server (113) of the merchant (or the centralized advertisement agency). In one embodiment, the interchange (101) is configured to send the advertisement message (218) to the mobile phone (117). In another embodiment, the server (113) of the merchant sends the advertisement message (218) to the mobile phone (117).

In one embodiment, in response to the purchase request generated on the mobile phone (117) when the advertisement message (218) in FIG. 24 is selected or replied to, the interchange (101) transmits a confirmation message (217), as illustrated in FIG. 25, to the mobile phone (117) to request a confirmation of the purchase request. In another embodiment, the interchange (101) may skip the confirmation message (217), when the purchase request is generated on the mobile phone (117) at the phone number (123).

FIG. 25 shows a message to confirm a purchase made via an advertisement on a mobile phone according to one embodiment. In FIG. 25, the confirmation message (217) provides the user with a number of options to pay for the purchase. For example, the user may select the option “1” to pay for the purchase with funds collected via the interchange (101) sending premium messages to the mobile phone (117). For example, the user may select the option “2” to pay for the purchase using the account information (121) associated in the data storage facility (107) with the phone number (123), such as a credit card number (or a debit card number, or a bank account).

In one embodiment, after the interchange (101) pays for the purchase using the funds associated with the phone number (123), the interchange (101) provides the mobile phone (117) with an electronic receipt, which indicates that the user of the mobile phone (117) has purchased and paid for the item.

In one embodiment, the receipt includes a code (e.g., a one time code), which can be presented to the merchant to obtain the purchased item. For example, the user may show the code to the merchant to pick up the purchased item.

In some embodiments, the purchased item is a virtual object which can be delivered to the user via the mobile phone (117). For example, the virtual object may be a song, an article, a receipt, a video clip, etc. In some embodiments, the virtual object may be delivered to the user via an email address associated with the phone number (123) in the data storage facility (107). In another embodiment, the purchased item is to be delivered to a street address of the user (e.g., identified from the user information (129)).

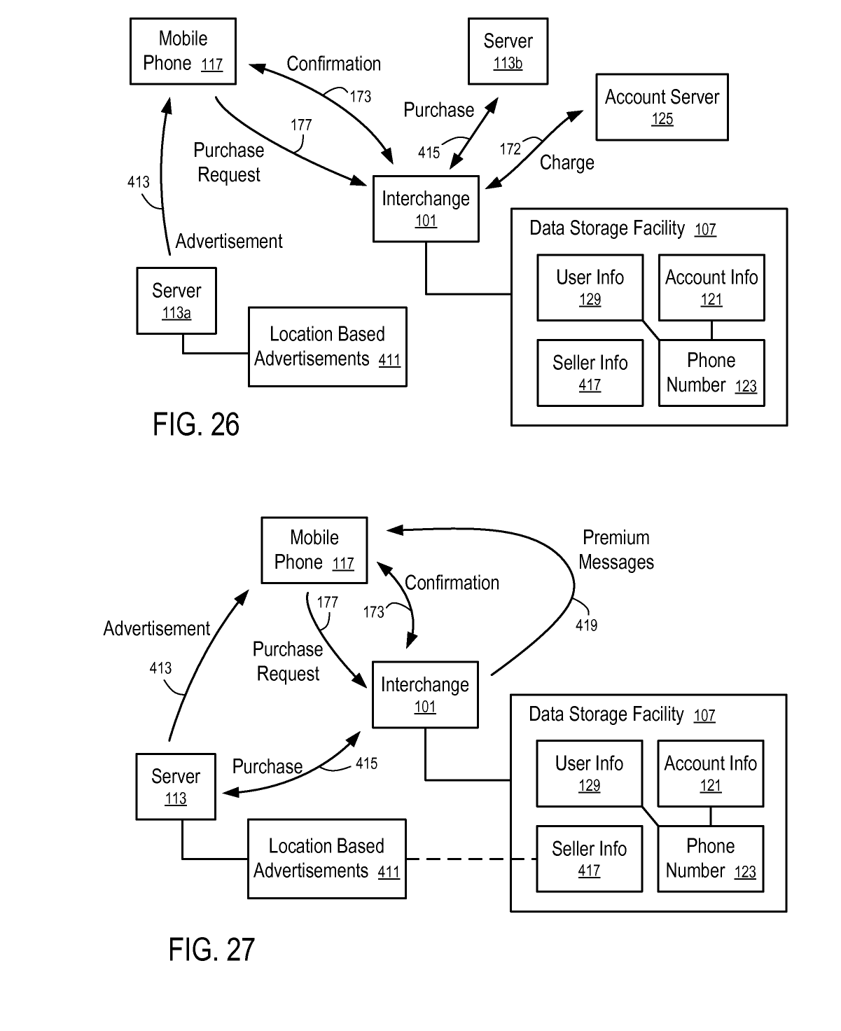

FIGS. 26-28 illustrate systems to facilitate purchases on a mobile phone according to some embodiments.

In FIG. 26, the server (113a) is configured to present location based advertisements (411) to the mobile phone (117). For example, an advertisement (413) may be selected from the location based advertisements (411) according to the current location of the mobile phone (117). The advertisement (413) includes the indication of an item, which is sent to the interchange (101) together with the purchase request (177) when the user of the mobile phone (117) selects the advertisement (413).

In FIG. 26, the purchase request (177) includes the phone number (123) of the mobile phone (117). The interchange (101) communicates with the mobile phone (117) for the confirmation (173). If the purchase request (177) is confirmed with the mobile phone (117), the interchange (101) communicates with server (113b) of the seller to make the purchase (415) on behalf of the user of the mobile phone (117).

In one embodiment, the interchange (101) stores the seller information (417) to identify the items and/or the sellers based on the information received from the purchase request (177). For example, the advertisement may include a code to represent the item and/or the seller. The purchase request (177) includes the code; and the interchange (101) uses the code to look up the item and/or the seller from the seller information (417) from the data storage facility (107).

In one embodiment, the data storage facility (107) also stores the account information (121) associated with the phone number (123). The interchange (101) uses the account information (121), such as a credit card number, a debit card number, a bank account number, etc., to collect funds from the user of the mobile phone (117) via electronic communications with the account server (125).

In one embodiment, the server (113a) configures the advertisement (413) to generate the purchase request (177) to the interchange (101) when the advertisement (413) is selected or replied to (e.g., by embedding a reference to the interchange (101) in the advertisement (413)). In some embodiments, the interchange (101) generates a code to represent the item and/or the seller; the code is provided to the sever (113a) for embedding in the advertisement (413). When the code is received from the mobile phone (117) in the purchase request (177), the interchange (101) uses the code to identify the corresponding item and/or seller.

In some embodiments, the server (113a) stores the seller information for the local based advertisements (411). After the interchange (101) receives the purchase request (177) that includes an identification of the advertisement (413), the interchange (101) communicates with the server (113a) to obtain details about the item for the confirmation (173) and/or the seller information for the purchase (415) on behalf of the user of the mobile phone (117).

In some embodiments, the advertisement (413) is sent from the server (113) of the merchant, as illustrated in FIG. 27. In FIG. 27, the interchange (101) registers items to be advertised as seller information (417) and provides codes to the server (113) of the merchant to represent the items. The server (113) of the merchant embeds the code in the advertisement (413), which is transmitted as part of the purchase request (177) to the interchange (101). In response to the purchase request (177), the interchange (101) extracts the code to identify the items purchased by the user and communicates with the server (113) of the merchant to make the purchase (415) on behalf of the user of the mobile phone (117).

In FIG. 27, after the confirmation (173) of the purchase request (177), the interchange (101) transmits premium messages (419) to the mobile phone (117) to collect funds for the purchase. Alternatively, the interchange (101) may use the account information (121) associated with the phone number (123) in the data storage facility (107) to electronically charge an account of the user to collect the funds.

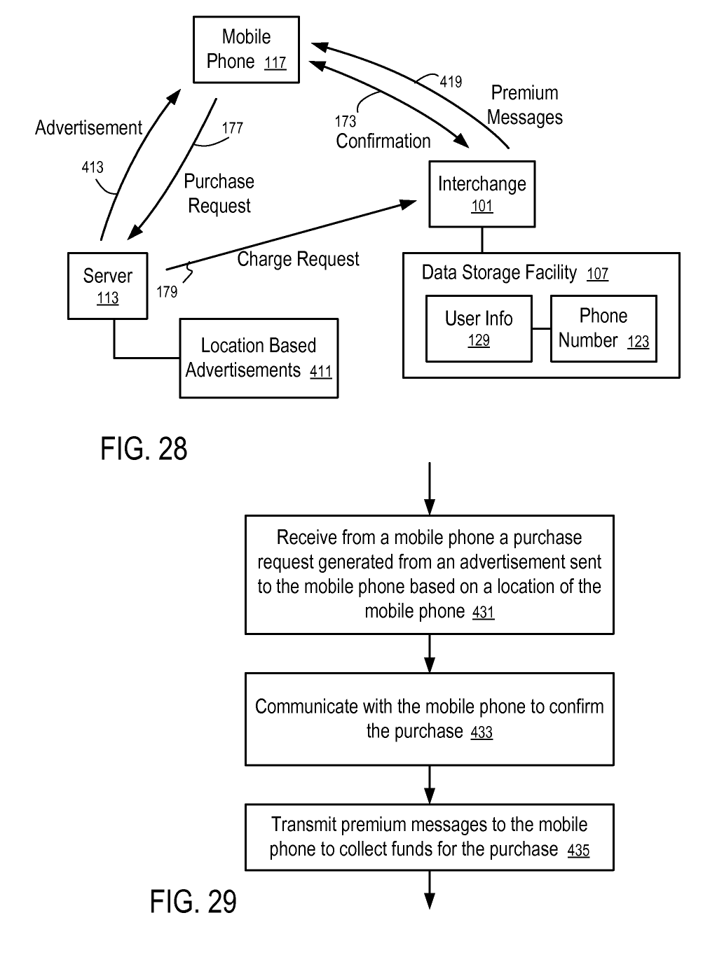

In some embodiments, the server (113) of the merchant communicates with the mobile phone (117) to present the advertisement (413) and to receive the purchase request (177), as illustrated in FIG. 28. In FIG. 28, the sever (113) of the merchant sends a charge request (179) to the interchange (101). The charge request (179) includes the phone number (123) of the mobile phone (117) that made the purchase request (177). Thus, in response to the charge request (179), the interchange (101) communicates with the mobile phone (117) to confirm the charge request (179). Once the charge request (179) is confirmed, the interchange (101) sends premium messages (419) to the mobile phone (117) to collect funds to satisfy the charge request (179).

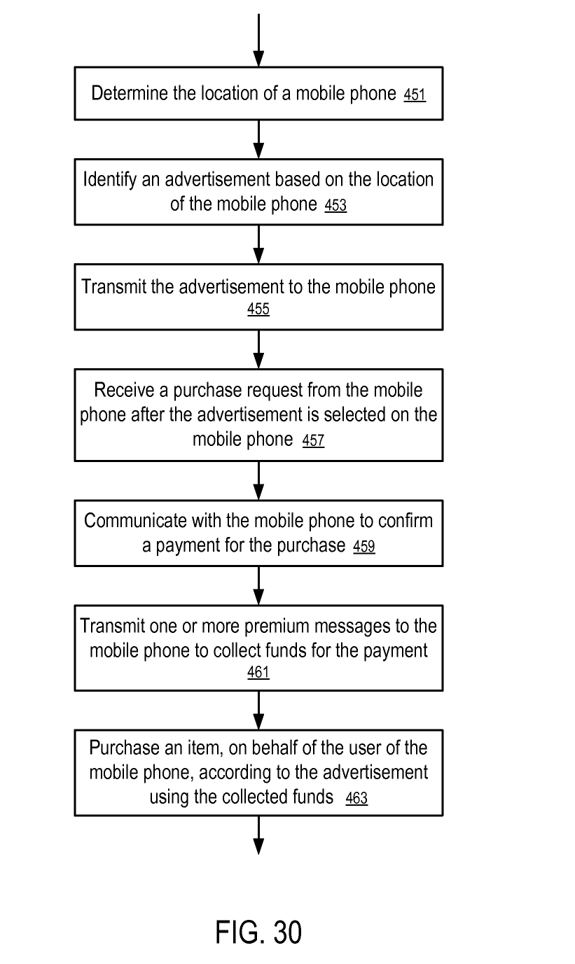

FIGS. 29-30 show methods to facilitate purchases on a mobile phone according to some embodiments.

In FIG. 29, the interchange (101) receives (431) from a mobile phone (117) a purchase request (177) generated from an advertisement (413) sent to the mobile phone (117) based on a location of the mobile phone (117). The interchange (101) communicates (433) with the mobile phone (117) to confirm the purchase and transmits (435) premium messages (419) to the mobile phone (117) to collect funds for the purchase.

In FIG. 30, after the location of a mobile phone (117) is determined (451), an advertisement is identified (453) based on the location of the mobile phone (117). The location may be determined by the mobile phone (117) based on wireless signals received at the mobile phone (117), such as Global Positioning System (GPS) signals, cellular telecommunication signals, etc. Alternatively, the location may be determined by a server based on signals transmitted from the mobile phone (117), such as cellular telecommunication signals received at one or more base stations for cellular communications. The advertisement may be identified by the interchange (101), the server (113) of a merchant, or the server (113a) of an advertisement agency. The advertisement is transmitted (455) to the mobile phone (117) for presentation to the user.

In FIG. 30, the interchange (101) receives (457) a purchase request (177) from the mobile phone (117) after the advertisement (413) is selected on the mobile phone (117). The purchase request (177) includes the phone number (123) of the mobile phone (117). The interchange (101) thus communicates (459) with the mobile phone (117) at the phone number (123) to confirm a payment for the purchase.

In one embodiment, the interchange (101) transmits (461) one or more premium messages (419) to the mobile phone (117) to collect funds for the payment.

In one embodiment, the interchange purchases (463) an item on behalf of the user of the mobile phone (117), according to the advertisement (413), using the collected funds.

In one embodiment, the interchange (101) stores seller information (417) identifying an item and a seller of the item. The item is presented in an advertisement (413) on a mobile phone (117) at a phone number (123). The advertisement (413) includes an indication of the item offered in the advertisement (413) and a reference to the interchange (101). When the advertisement (413) is selected (or replied to), the advertisement (413) causes the mobile phone (117) to generate a purchase request (177) that includes the indication of the item offered in the advertisement (413) and the phone number (123) of the mobile phone (117). The interchange (101) identifies the seller based on the indication of the item and the seller information (417) stored by the server computer to electronically purchase the item on behalf of a user of the mobile phone (117).

In one embodiment, the one or more premium messages are sent to the mobile phone (117) in response to the user confirming the request via the mobile phone (117). In other embodiments, premium messages are sent to the mobile phone (117) to collect funds into an account hosted on the interchange (101) before the purchase request (177) is made.

In one embodiment, to confirm the purchase request (177), the interchange (101) sends a message to the mobile phone (117) at the phone number (123) via short message service (SMS) and receives a reply to the message via SMS. If no reply is received from the mobile phone (117) within a predetermined period of time, the purchase request (177) is rejected.

In one embodiment, the seller has a presence near the location of the mobile phone (117); and after the user purchases the item via the mobile phone (117), the user can go to the seller to pick up the purchased item. In one embodiment, the seller delivers the item electronically to the mobile phone (117).

In one embodiment, the interchange (101) sends to the mobile phone (117) a message to confirm completion of purchasing the item from the seller, such as a message containing a receipt for the purchase. In one embodiment, the message includes a code identifying that the item is paid for by the user of the mobile phone (117).

In one embodiment, the interchange (101) identifies an address of the user based on the user information (129) stored with the phone number (123) on the data storage facility (107). The interchange (101) communicates the address of the user to the seller to facilitate delivery of the item. The address may be an email address for the delivery of virtual goods (and/or the receipt, a token representing the purchases item, etc.), or a street address for the delivery of physical goods.

In one embodiment, the interchange (101) receives from the seller the information identifying the item and the seller of the item, and provides to the seller a code to be embedded in the advertisement (413). The code is to cause the advertisement (413) to include the reference to the interchange (101) and the indication of the item. In one embodiment, the code is to further cause the purchase request (177) to include the phone number (123) of the mobile phone (117).

In one embodiment, the advertisement (413) is received in the mobile phone (117) via text messaging; and the purchase request (177) is transmitted to the interchange (101) via text messaging.

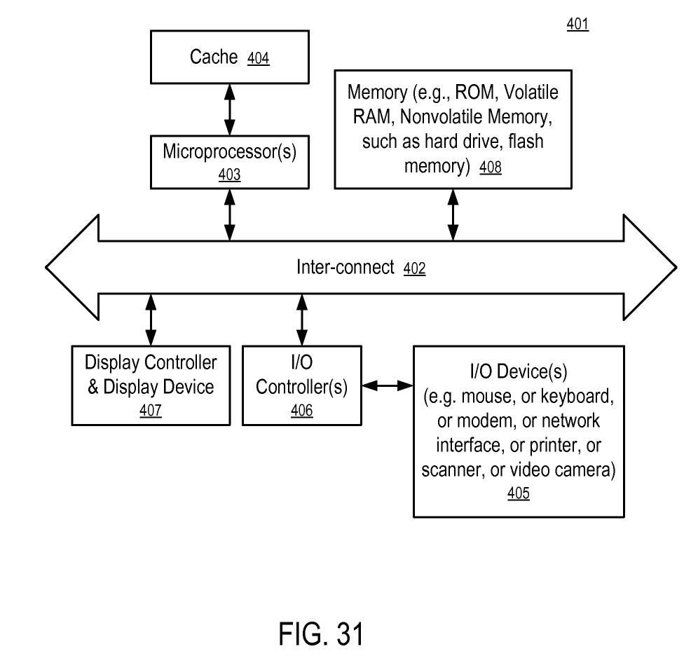

FIG. 31 shows a data processing system, which can be used in various embodiments. While FIG. 31 illustrates various components of a computer system, it is not intended to represent any particular architecture or manner of interconnecting the components. Some embodiments may use other systems that have fewer or more components than those shown in FIG. 31.

In one embodiment, each of the interchange (101), the data storage facility (107), the controllers (115), the mobile phones (117), the user terminals (111), the account server (125) and the servers (113) can be implemented as a data processing system, with fewer or more components, as illustrated in FIG. 31.

In FIG. 31, the data processing system (401) includes an inter-connect (402) (e.g., bus and system core logic), which interconnects a microprocessor(s) (403) and memory (408). The microprocessor (403) is coupled to cache memory (404) in the example of FIG. 31.

The inter-connect (402) interconnects the microprocessor(s) (403) and the memory (408) together and also interconnects them to a display controller, display device (407), and to peripheral devices such as input/output (I/O) devices (405) through an input/output controller(s) (406).

Typical I/O devices include mice, keyboards, modems, network interfaces, printers, scanners, video cameras and other devices which are well known in the art. In some embodiments, when the data processing system is a server system, some of the I/O devices, such as printer, scanner, mice, and/or keyboards, are optional.

The inter-connect (402) may include one or more buses connected to one another through various bridges, controllers and/or adapters. In one embodiment, the I/O controller (406) includes a USB (Universal Serial Bus) adapter for controlling USB peripherals, and/or an IEEE-1394 bus adapter for controlling IEEE-1394 peripherals.

The memory (408) may include ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, various functions and operations may be described as being performed by or caused by software code to simplify description. However, those skilled in the art will recognize that what is meant by such expressions is that the functions result from execution of the code/instructions by a processor, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a tangible machine readable medium includes any apparatus that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A computer-implemented method, comprising:
storing, by a server computer, information identifying an item and a seller of the item, the item to be presented in an advertisement to a mobile phone at a phone number, the advertisement having a reference to the server computer to generate a request to the server computer when the advertisement is selected, the advertisement further having an indication of the item offered in the advertisement;
receiving, at the server computer, the request generated in response to the advertisement being selected in the mobile phone, the request including the indication of the item and the phone number of the mobile phone;
identifying, by the server computer, the seller based on the indication of the item and the information stored by the server computer; and
communicating, by the server computer, with a server of the seller to electronically purchase the item on behalf of a user of the mobile phone, using the funds associated with the phone number.

2. The method of claim 1, further comprising:
communicating, by the server computer, with the mobile phone to confirm the request to purchase the item using funds associated with the phone number; and
sending one or more premium messages from the server computer to the mobile phone to collect the funds.

3. The method of claim 2, wherein the one or more premium messages are sent to the mobile phone in response to the user confirming the request via the mobile phone.

4. The method of claim 3, wherein the communicating, by the server computer, with the mobile phone to confirm the request comprises:
sending a message to the mobile phone at the phone number via short message service (SMS); and
receiving a reply to the message via SMS.

5. The method of claim 2, wherein the one or more premium messages are sent to the mobile phone prior to the advertisement being selected on the mobile phone; and the funds are stored in an account hosted on the server computer prior to the server computer purchasing the item on behalf of the user.

6. The method of claim 1, further comprising:
identifying financial information of the user based on the phone number included in the request; and
charging the user using the financial information to obtain the funds.

7. The method of claim 6, wherein the financial information includes one of a credit card number, a bank account number, and a debit card number.

8. The method of claim 1, wherein the advertisement is provided to the mobile phone in response to a determination of a location of the mobile phone.

9. The method of claim 8, wherein the advertisement is selected for presentation on the mobile phone based on the location of the mobile phone.

10. The method of claim 8, wherein the seller has a presence near the location of the mobile phone.

11. The method of claim 1, wherein the seller delivers the item electronically to the mobile phone.

12. The method of claim 1, further comprising:
sending, by the server computer to the mobile phone, a message to confirm completion of purchasing the item from the seller.

13. The method of claim 12, wherein the message includes a code identifying that the item is paid for by the user of the mobile phone.

14. The method of claim 1, further comprising:
identifying an address of the user based on the phone number included in the request; and
communicating the address of the user to the seller to facilitate delivery of the item.

15. The method of claim 14, wherein the address comprises one of: an email address, and a street address.

16. The method of claim 1, further comprising:
receiving, by the server computer from the seller, the information identifying the item and the seller of the item; and
providing, by the server computer to the seller, a code to be embedded in the advertisement, the code causing the advertisement to include the reference to the server computer and the indication of the item.

17. The method of claim 16, wherein the code is to further cause the request to include the phone number.

18. The method of claim 1, wherein the advertisement is received in the mobile phone via text messaging; and the request is transmitted to the server computer via text messaging.

19. A computer-readable storage media storing instructions, the instructions causing a server computer to perform a method, the method comprising:
receiving, at the server computer, a request generated in response to an advertisement being presented and selected on a mobile phone, the request identifying an item, a seller of the item, and a phone number of the mobile phone;
communicating, by the server computer, with the mobile phone to confirm the request to purchase the item;
sending, by the server computer, one or more premium messages to the mobile phone at the phone number to collect funds for purchase of the item; and
communicating, by the server computer, with a server of the seller to electronically purchase the item on behalf of a user of the mobile phone, using the funds collected via the one or more premium messages.

20. A system, comprising:
a data storage facility to store information identifying an item and a seller of the item, the item to be presented in an advertisement to a mobile phone at a phone number; and
an interchange coupled with the data storage facility, the interchange including a common format processor and a plurality of converters to interface with a plurality of controllers, the converters configured to communicate with the controllers in different formats, the converters to communicate with the common format processor in a common format, the advertisement having an indication of the item offered in the advertisement and a reference to the interchange to generate a request to the interchange when the advertisement is selected, the request including the indication of the item and the phone number of the mobile phone, the common format processor to instruct a first controller of the controllers, via a first converter of the converters, to communicate with a mobile phone at the mobile phone number of the user to
confirm the request to purchase the item with funds associated with the phone number, and
send one or more premium messages to the mobile phone to collect the funds;
wherein the interchange is configured to identify the seller based on the indication of the item and the information stored in the data storage facility and communicate with a server of the seller to electronically purchase the item on behalf of a user of the mobile phone, using the funds.
